(19) United States
(12) Patent Application Publication
(10) Pub. No.: US 2002/0118215 A1
(43) Pub. Date: Aug. 29, 2002

(54) Method and system for providing block animation

(76) Inventors: Brian Ball, Roanoke, VA (US); Christopher Tschappatt, Roanoke, VA (US)

Correspondence Address: Thomas M. Blasey, Esq., Hunton & Williams, Suite 1200, 1900 K Street, N.W., Washington, DC, 20006-1109, US

(21) Appl. No.: 09/791,907

(22) Filed: Feb. 23, 2001

(51) Int. Cl. G09G 5/00

(52) U.S. Cl. 345/619

(57) ABSTRACT

The invention provides a method and system for displaying the internal functions of a block. A user identifies a selected block having a block identifier. A data file having a plurality of drawing files is searched, using the block identifier, to identify a matching drawing file that is associated with the block identifier. The matching drawing file is scanned to identify special character items in the matching drawing file. Each special character item that is identified in the scanning is associated with a graphics item. Each special character item that is identified in the scanning is then stripped from the matching drawing file to generate a modified matching drawing file. A display is generated based on the modified matching drawing file and each identified graphics item representing the internal functions of the block.

### FIELD OF THE INVENTION

The present invention generally relates to a system and method for graphically displaying the internal operation of a block.

### BACKGROUND OF THE INVENTION

A block or multiple blocks may be used in a variety of applications. For example, such a block may be utilized in a controller system. Controller systems are commonly used in a variety of environments to control an operating field device, for example. Illustratively, the operating field device may be a gas or hydrodynamic power generation device. A typical controller system includes a computer workstation with a user interface, and a controller device. A human user interacts with the computer workstation to monitor and control parameters in the controller device. In turn, the controller device controls the operating field device. Typically, the computer workstation includes a suitable controller configuration application. A suitable communication network is used to allow communication between the computer workstation, the controller device and the operating field device.

The controller configuration application on the computer workstation may be used to control and monitor the controller device in a variety of ways. Illustratively, a controller configuration application may provide graphically-based editing of configuration application code, block, macro and module libraries, live data block flow diagrams, input and output configuration and monitoring, signal management and signal trending, report generation, batch operation, and file management, for example.

Controller systems, utilizing these controller configuration applications, are known to utilize blocks and the associated block's functionality in a variety of configurations. These controller configuration applications may also provide a graphical representation of the block functions by displaying the function inputs and outputs as “pins”, so named for their similarity to pins of an integrated-circuit chip. Such a representation has typically been shown as a block with inputs on one side of the block and outputs on the other side of the block. Thus, when the computer workstation is connected to the controller device, live data can be observed on the pins of the blocks.

However, the user cannot see the inner workings of the block and any intermediate states as the live data is manipulated in the block. Consequently, due to the complexity of the blocks and the known methods for depicting block functionality, known controller systems do not show sufficient detail to aid a user in understanding the functionality of a block.

### SUMMARY OF THE INVENTION

It would be desirable to provide a method and system wherein a user would be able to view the internal functionality of a block such that the user could easily understand the operation of the block. It would further be desirable to provide a method and system of configuring, monitoring and observing a controller device, wherein the user would have the ability to see live data inside a functioning block that is used to monitor and control the controller device.

The present invention overcomes the disadvantages of known systems, and achieves additional advantages, by providing a method and system for displaying the internal functions of a block. A user identifies a selected block having a block identifier. A data file having a plurality of drawing files is searched, using the block identifier, to identify a matching drawing file that is associated with the block identifier. The matching drawing file is scanned to identify special character items in the matching drawing file. Each special character item that is identified in the scanning is associated with a graphics item. Each special character item that is identified in the scanning is then stripped from the matching drawing file to generate a modified matching drawing file. A display is generated based on the modified matching drawing file and each identified graphics item representing the internal functions of the block.

### BRIEF DESCRIPTION OF THE DRAWINGS

The present invention can be more fully understood by reading the following detailed description of the presently preferred embodiments together with the accompanying drawings, in which like reference indicators are used to designate like elements, and in which:

FIG. 1 is a diagram showing an illustrative user interface in accordance with an embodiment of the system and method of the invention;

FIG. 2 is a diagram showing a user interface containing blocks in accordance with an embodiment of the system and method of the invention;

FIG. 3 is a diagram showing a user interface containing a block drawing in accordance with an embodiment of the system and method of the invention;

FIG. 4 is a diagram showing a further aspect of the user interface in accordance with an embodiment of the system and method of the invention;

FIG. 5 is a diagram showing a further aspect of the user interface in accordance with an embodiment of the system and method of the invention;

FIG. 6 is a diagram showing a further aspect of the user interface in accordance with an embodiment of the system and method of the invention;

FIG. 7 is a diagram showing a further aspect of the user interface in accordance with an embodiment of the system and method of the invention;

FIG. 8 is a diagram showing a further aspect of the user interface in accordance with an embodiment of the system and method of the invention;

FIG. 9 is a diagram showing a further aspect of the user interface in accordance with an embodiment of the system and method of the invention;

FIG. 10 is a diagram showing a further aspect of the user interface in accordance with an embodiment of the system and method of the invention;

FIG. 11 shows an illustrative operating system, controller device and operating field device in accordance with an embodiment of the system and method of the invention;

FIG. 12 shows the controller portion of FIG. 11 in further detail in accordance with one embodiment of the system and method of the invention;

FIG. 13 shows the option selection portion of FIG. 12 in further detail in accordance with one embodiment of the system and method of the invention;

FIG. 14 shows the task execution portion of FIG. 12 in further detail in accordance with one embodiment of the system and method of the invention;

FIG. 15 shows the metafile navigation portion of FIG. 13 in further detail in accordance with one embodiment of the system and method of the invention;

FIG. 16 shows the input/output control portion of FIG. 11 in further detail in accordance with one embodiment of the system and method of the invention;

FIG. 17 shows the user interface portion of FIG. 11 in further detail in accordance with one embodiment of the system and method of the invention;

FIG. 18 shows the configuration display portion of FIG. 17 in further detail in accordance with one embodiment of the system and method of the invention;

FIG. 19 shows the configuration content modification portion of FIG. 17 in further detail in accordance with one embodiment of the system and method of the invention;

FIG. 20 shows the function summarization portion of FIG. 18 in further detail in accordance with one embodiment of the system and method of the invention;

FIG. 21 shows the block functionality portion of FIG. 18 in further detail in accordance with one embodiment of the system and method of the invention;

FIG. 22 shows the memory of FIG. 12 in further detail in accordance with one embodiment of the system and method of the invention;

FIG. 23 shows the operating memory of FIG. 22 in further detail in accordance with one embodiment of the system and method of the invention;

FIG. 24 shows the data memory of FIG. 22 in further detail in accordance with one embodiment of the system and method of the invention;

FIG. 25 shows the configuration A memory of FIG. 23 in further detail in accordance with one embodiment of the system and method of the invention;

FIG. 26 shows the metafile library memory of FIG. 25 in further detail in accordance with one embodiment of the system and method of the invention;

FIG. 27 shows the metafile functionality memory of FIG. 24 in further detail in accordance with one embodiment of the system and method of the invention;

FIG. 28 is a flow chart showing a process in accordance with one embodiment of the system and method of the invention;

FIG. 29 is a flow chart that shows the “block designer creates and installs new block and block diagram in controller configuration application” step of FIG. 28 in further detail in accordance with one embodiment of the system and method of the invention;

FIG. 30 is a flow chart that shows the “block designer generates detailed graphical drawing of block internal functionality” step of FIG. 29 in further detail in accordance with one embodiment of the system and method of the invention;

FIG. 31 is a flow chart that shows the “user accesses the controller configuration application in an operating system” step of FIG. 28 in further detail in accordance with one embodiment of the system and method of the invention;

FIG. 32 is a flow chart that shows the “user selects a configuration based on the controller device being configured” step of FIG. 28 in further detail in accordance with one embodiment of the system and method of the invention;

FIG. 33 is a flow chart that shows the “user operatively communicates the operating system with the controller device” step of FIG. 28 in further detail in accordance with one embodiment of the system and method of the invention;

FIG. 34 is a flow chart that shows the “operating system receives inputs from the controller device of the operating device” step of FIG. 33, in further detail in accordance with one embodiment of the system and method of the invention;

FIG. 35 is a flow chart that shows the “operating system dispatches outputs from the operating system based on the configuration” step of FIG. 33 in further detail in accordance with one embodiment of the system and method of the invention;

FIG. 36 is a flow chart that shows the “operating system executes the functionality and operation of the configuration for a controller device and operating field device” step of FIG. 28 in further detail in accordance with one embodiment of the system and method of the invention;

FIG. 37 is a flow chart that shows the “user utilizes the operating system to display the internal operation and functionality of the controller device configuration” step of FIG. 28 in further detail in accordance with one embodiment of the system and method of the invention;

FIG. 38 is a flow chart that shows additional aspects of the “user utilizes the operating system to display the internal operation and functionality of the controller device configuration” step of FIG. 28 in further detail in accordance with one embodiment of the system and method of the invention; FIG. 39 is a flow chart that shows the “read the name portion of the text function and compare to a known list of signals on the I/O data list” step of FIG. 38 in further detail in accordance with one embodiment of the system and method of the invention; and

FIG. 40 is a flow chart that shows the “create an object to contain the placement and type information of the text function” step of FIG. 38 in further detail in accordance with one embodiment of the system and method of the invention.

### DETAILED DESCRIPTION OF THE INVENTION

In accordance with one embodiment of the system and method of the invention, the block designer, i.e., a human person, creates blocks that will be distributed with a controller configuration application, for use in the configuration of the controller device. The operating field device might be a generator, for example.

Once a block is complete, the block designer creates a graphical representation, in the form of a drawing data file, of the block's internal functionality such that the representation may be accessed in the controller configuration application. When finished, the block designer saves each block's drawing data file in the form of a metafile in a library that is supplied with the controller configuration application. Then, the controller configuration application is sold or otherwise provided to an end user. The end user uses the controller configuration application to control and monitor a controller device, which in turn controls an operating field device.

In order to utilize the invention, a user first accesses the controller configuration application. In the controller configuration application, the user can select from a range of configuration files that she will employ to configure, monitor and modify the configuration of a controller device.

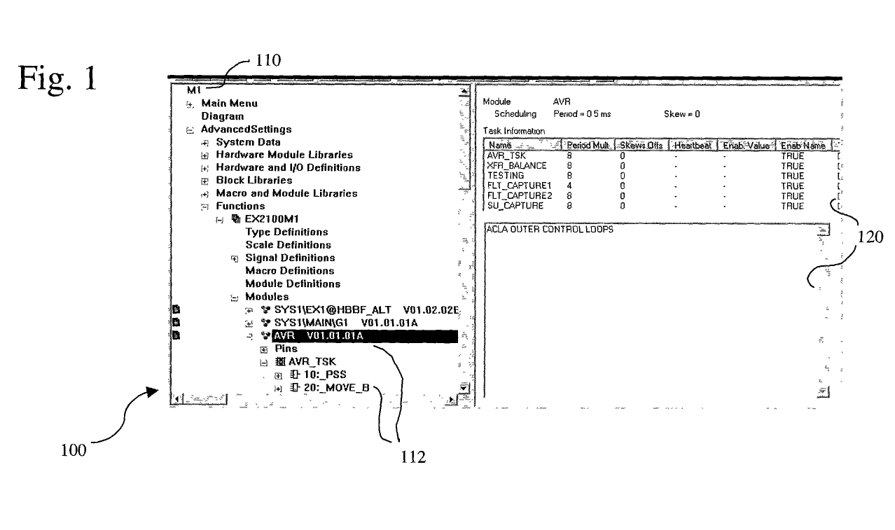

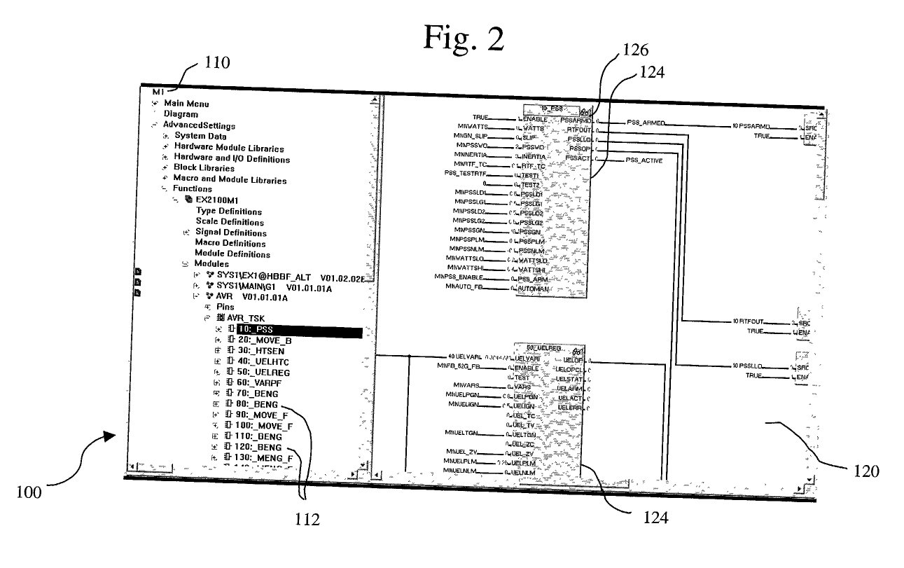

FIG. 1 shows an illustrative user interface 100 in accordance with an embodiment of the method and system of the invention . The user interface 100 includes a configuration file 110, that has been selected. That is, once the user selects a configuration file 110, the controller configuration application loads the configuration file 110 and displays its configuration items 112, i.e., blocks, macros, modules, tasks, or functions, for example, on a user interface 100 as shown in FIG. 1, as well as FIG. 2. The controller configuration application structures the configuration items in a hierarchy to simplify the use of the configuration items. Illustratively, an instruction block may constitute a basic control item. Instruction blocks are connected to form macros. Tasks are made up of macros and blocks. Furthermore, tasks are grouped together to form modules. Finally, the function is the highest form of grouping in the hierarchy and defines the process that is being controlled.

Thus, the user is presented with a hierarchical view of the available configuration items 112. Additionally, the user is presented with a function summary view 120 that shows a graphical representation of the functional information in the selected configuration item 112. In an effort to more accurately display the hierarchy of the configuration items 112, the user is presented with a “tree” view of the configuration items 112 of the configuration file 110.

In the function summary view 120, the internal functions of the configuration file 110 are displayed by blocks 124, as shown in FIG. 2. However, these summarized views are of limited assistance in understanding the functionality of a particular block 124 associated with a highlighted configuration item 112.

In accordance with one embodiment of the method and system of the invention, when the user selects a configuration file 110 and highlights a given configuration item 112, the system of the invention looks for detailed drawing data files associated with the configuration item 112, i.e., the highlighted block, macro, module, task or function. That is, the system of the invention compares available detailed drawing data files with the selected configuration item 112 and matches the selected configuration item 112 to a detailed drawing data file by name, or by any other suitable association. Thus, the invention displays a representative symbol, i.e., a metafile alert symbol 126, on each matched block 124 in the function summary view 120. As a result, the user understands that a more detailed drawing capturing the functionality of that block 124 can be accessed.

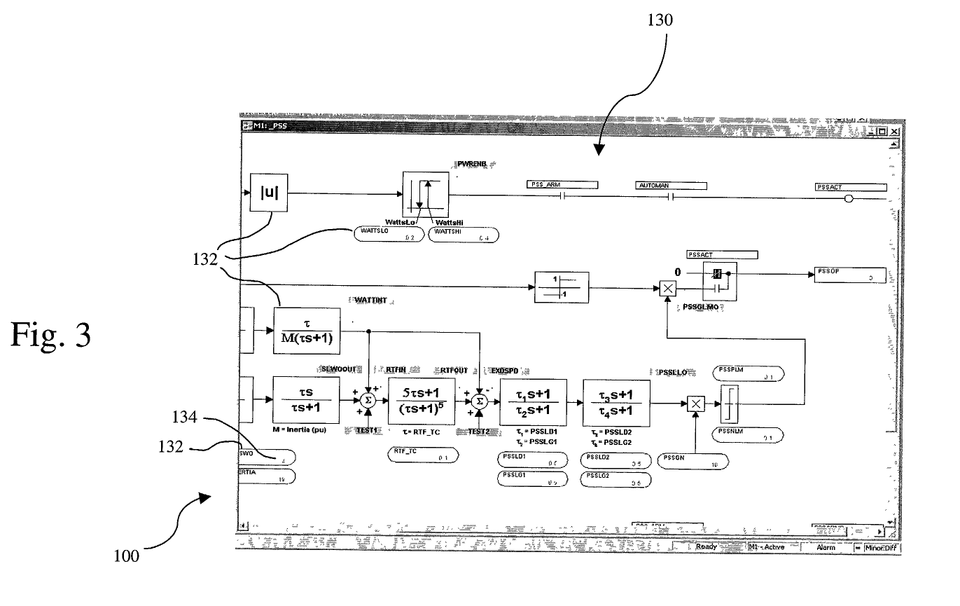

If the user chooses to see the more detailed block drawing by selecting a block drawing displaying a representative symbol 126, the system of the invention scans the drawing data file and compares all of the text functions in the block drawing with standardized text functions that the system of the invention understands represent a functional attribute or data signal, for example, in the block 124. The system of the invention then displays a block drawing 130, as shown in FIG. 3, and provides an active communication between the functional aspects contained in the block drawing 130 and the inputs and outputs from or to a controller device. Thus, the system of the invention provides a method of viewing the internal functionality of the configuration file 110 and gaining a better understanding of the functionality, as well as providing a technique within which the user can modify the parameter settings, device controls, and data values, for example, in a block 124. As described herein, a “text function” may also be characterized as a “text function item.” As described above, the metafile alert symbol 126 tells the user that a further representation of a particular block's functionality exists, i.e., a block drawing 130 exists. The user can select the metafile alert symbol 126 and “drill” into the block, i.e., initiate the display of the block drawing 130. When the user chooses to see the block drawing 130, the invention scans the associated block drawing file for text functions containing special characters. The special characters embedded in the text functions alert the system of the invention that a given point on the block drawing 130 represents a functional input in the configuration item 112, either in the form of live signal data, parameter settings, relay and coil contacts, or edit signal types, for example. The signal name corresponds to a signal input or output to the block.

The drawing file, i.e., a drawing data file, contains multiple text functions. Each of the text functions in the drawing data file includes a name portion. Additionally, each text function may or may not contain special characters.

The system of the invention analyzes any special characters embedded in the text functions and compares them to a known list of special characters representing functional aspects of blocks in a controller configuration application. Once the system of the invention matches the special characters with a known aspect of block functionality, the invention strips the special character from the text function, remembers the location of the text function on the block drawing by X, Y coordinates or other suitable positional coordinates, and draws a representative object of the block functional aspect represented in the text function on the user interface with the name it was given. It should be appreciated that the representative objects may be stored in a suitable memory.

As described above, FIG. 3 shows a user interface 100 containing a block drawing 130. The block drawing 130 represents the internal features of the block 124 by displaying various objects 132 and their various attributes. For example, the block drawing 130 shows an object value 134. Various other attributes of the displayed block are shown.

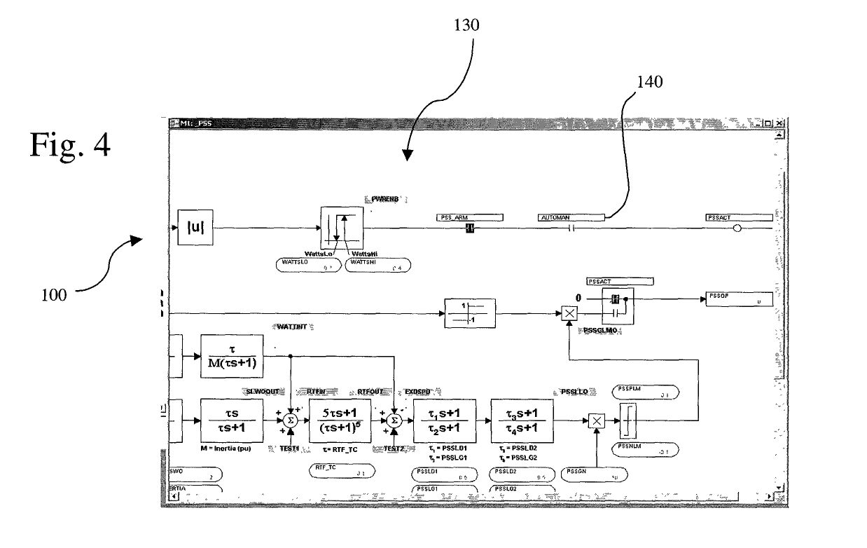

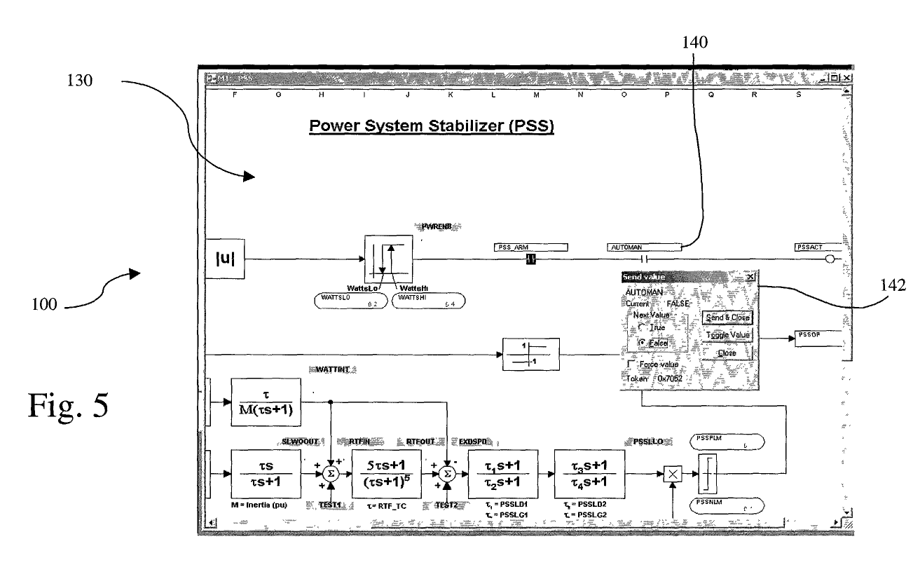

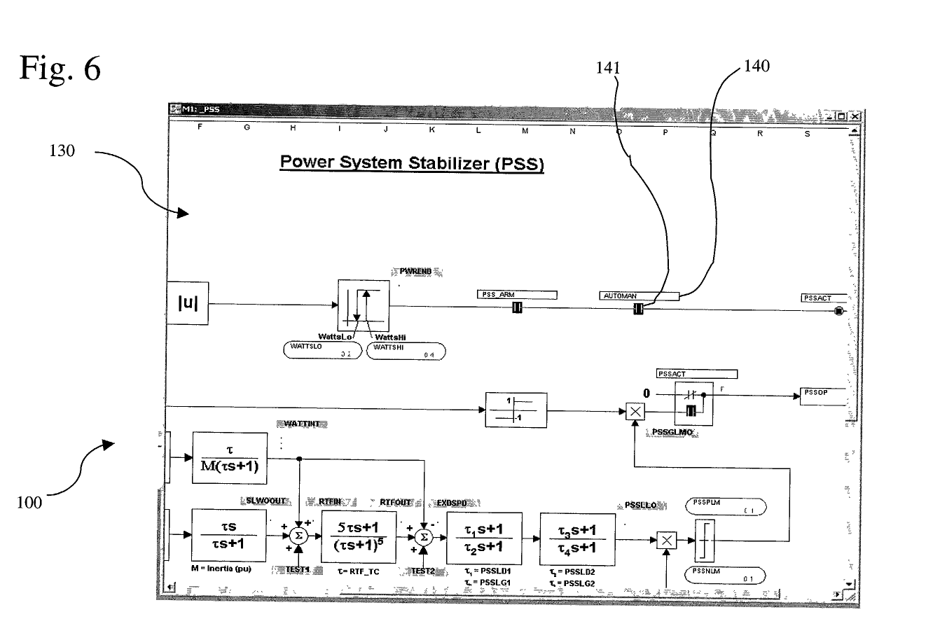

It should be appreciated that the user interface 100 is interactive and allows a user to perform various operations. For example, a contact 140 is shown in FIG. 4. As shown in FIG. 4, a lack of an inverse video behind contact 140 indicates that contact 140 is open. However, a user may wish to “force” the contact 140 closed. The user may select the contact 140 in any suitable manner so as to generate a dialogue box 142, as shown in FIG. 5. The dialogue box 142 allows a user to force the contact 140 closed. Accordingly, as shown in FIG. 6, the contact 140 is closed as shown by the inverse video 141 behind the contact 140.

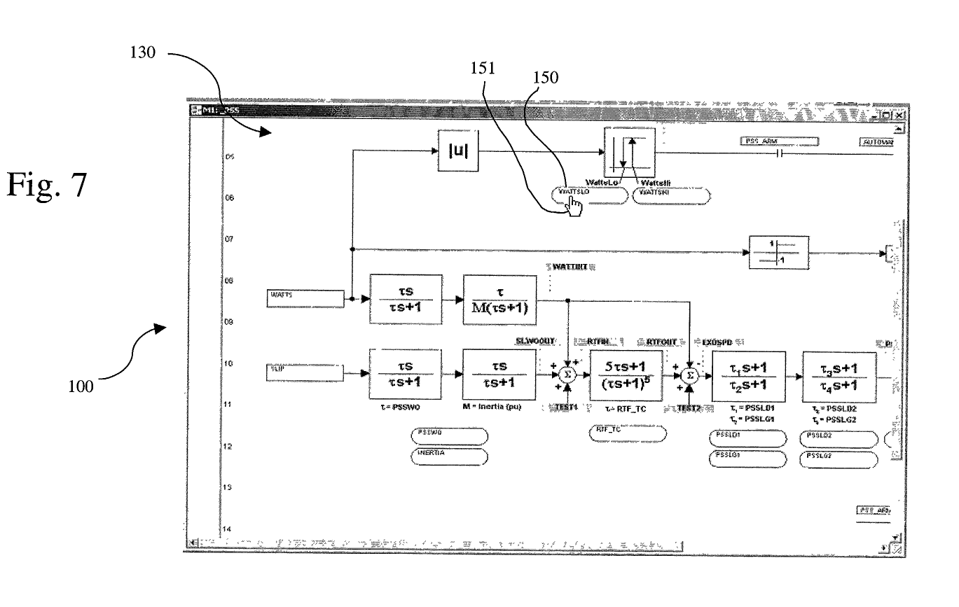

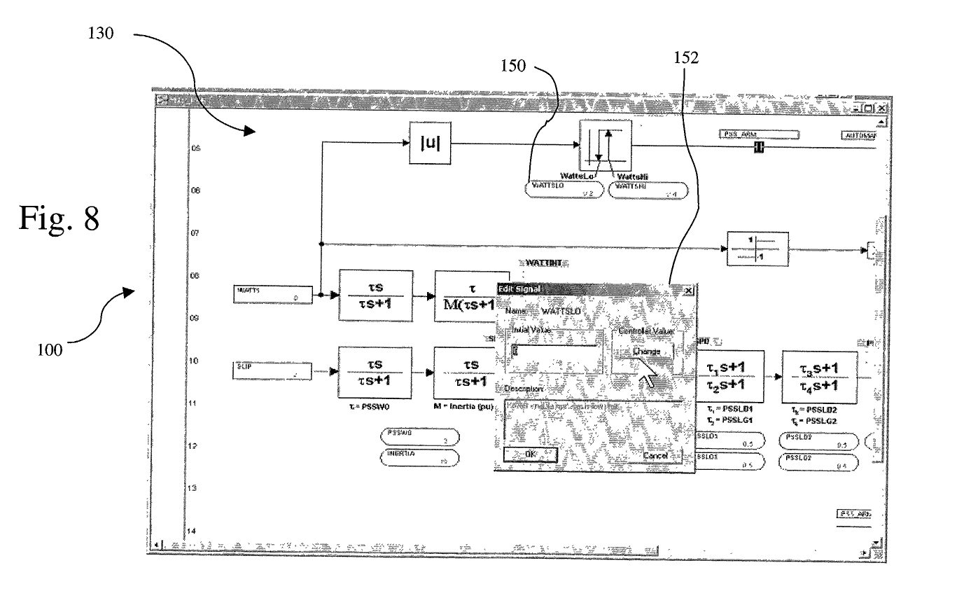

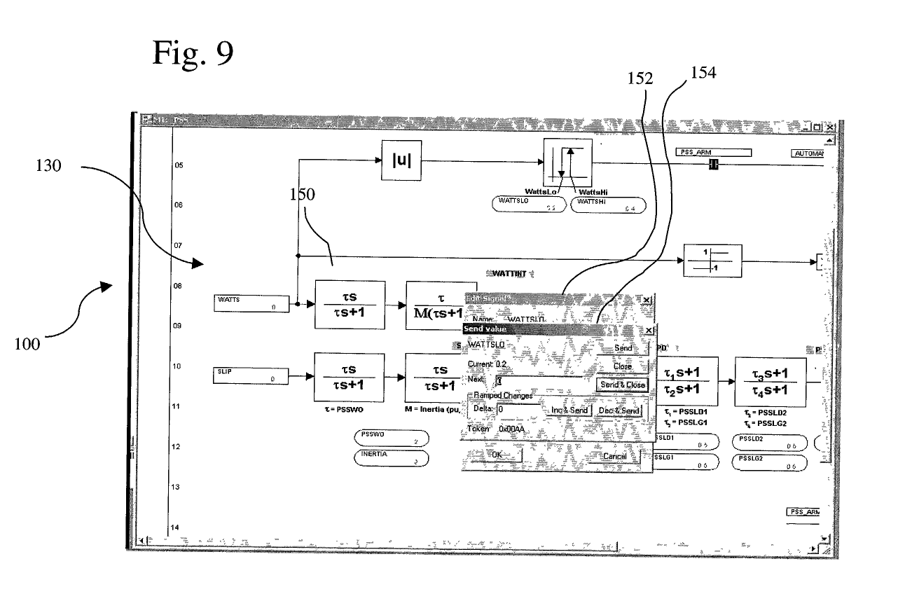

FIG. 7 shows a user interface 100 illustrating a further aspect of an embodiment of the system and method of the invention. As shown in FIG. 7, a representative object 150 possesses an initial value as a result of a block input signal. As shown in FIG. 7, a hand cursor 151 may be used to show an object that can be selected. That is, a typical arrow shaped cursor, for example, changes to the hand cursor 151 when positioned over an object that can be operated on. Thus, for example, the hand cursor 151 shows that a user may change the value in the representative object 150. That is, the user may select to change the value in the representative object 150, by any suitable manner, so as to generate the dialog box 152, as shown in FIG. 8. Accordingly, the signal edit dialog box 152 is generated on the user interface 100 and allows the user to change the initial value of the signal of the representative object 150. The user may also change the corresponding value in the controller device using a controller edit dialog box 154, as shown in FIG. 9. Accordingly, the user interface 100 allows a user to “force” a signal in a controller device utilizing the controller edit dialog box 154.

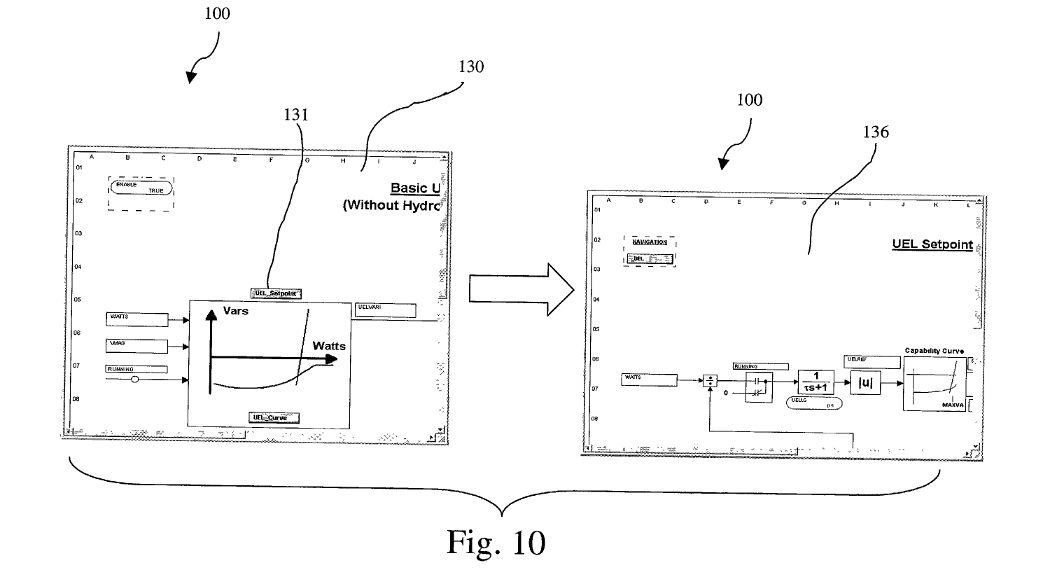

It should be appreciated that some blocks may be sufficiently complex so as to require multiple levels of detailed drawings. Such a situation is shown in FIG. 10. Accordingly, a user may further “drill” into the block drawing 130, i.e., the first level of detail which shows some variables and some information, and observe a further level of detail. Specifically, as shown in FIG. 10, the block drawing 136 shows a second level of detail that displays further information about how a particular function in the block drawing 130 performs. For example, a user may select the “UEL -Setpoint” button 131 as shown in FIG. 10. In response to such selection, an operating system subsequently displays the block drawing 136.

As described above, in conjunction with creation of a block, once a block is complete, the block designer creates a graphical representation, in the form of a drawing data file, of the block's internal functionality. When finished, the block designer saves each block's drawing data file in the form of a metafile. However, it should be appreciated that a drawing data file may be created for currently existing blocks. For example, the repeated customer support needed for a particular block may justify the creation of a drawing data file as described herein.

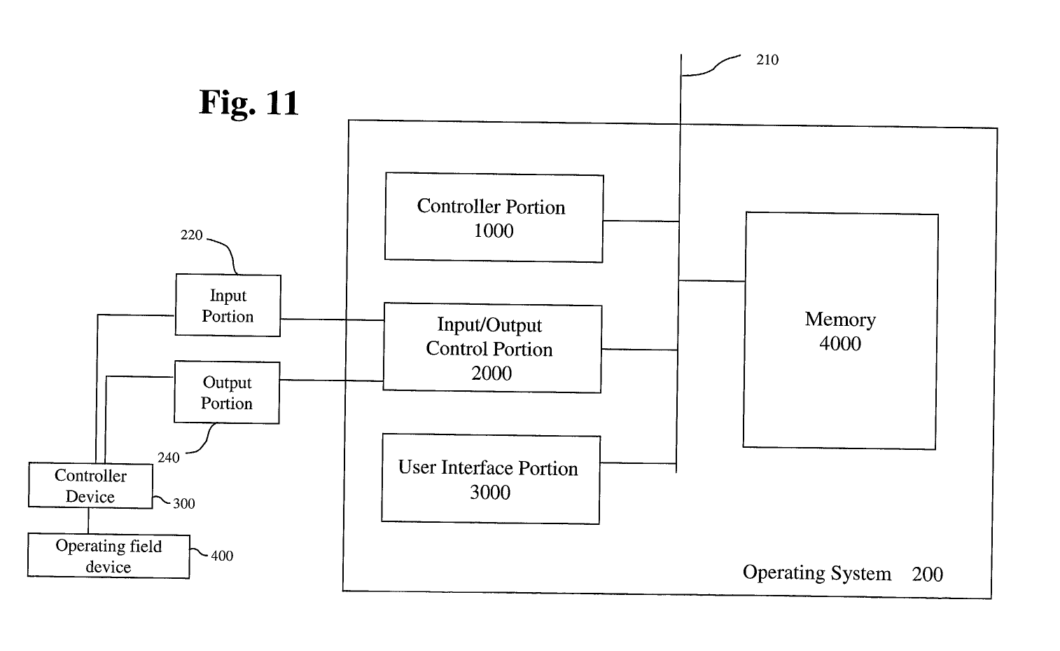

FIG. 11 shows an illustrative operating system 200, a controller device 300, and an operating field device 400, in accordance with one embodiment of the system and method of the invention. As shown in FIG. 11, the operating system 200, the controller device 300, and the operating field device 400 are connected over a suitable communications network. Thus, the user can access the operating system 200 to observe, monitor, control and configure the controller device 300, which in turn controls and reports the inputs/outputs of the operating field device 400. Furthermore, the user can effect configurations of the controller device 300 using the operating system 200 without live communication between the two devices, i.e., the configuration can be modified offline and operatively communicated when the user is ready.

Also shown in FIG. 11, the operating system 200 includes controller portion 1000, the input/output control portion 2000, a user interface portion 3000, and a memory 4000. The operating system 200 monitors input using an input portion 220, from the controller device 300 and communicates output, using the output portion 240, to the controller device 300. A suitable communications path may be utilized to allow communication between the components of the operating system 200. Accordingly, as shown in FIG. 11, an interface 210 allows the controller portion 1000, the input/output control portion 2000, the user interface portion 3000, and the memory 4000 to communicate with each other.

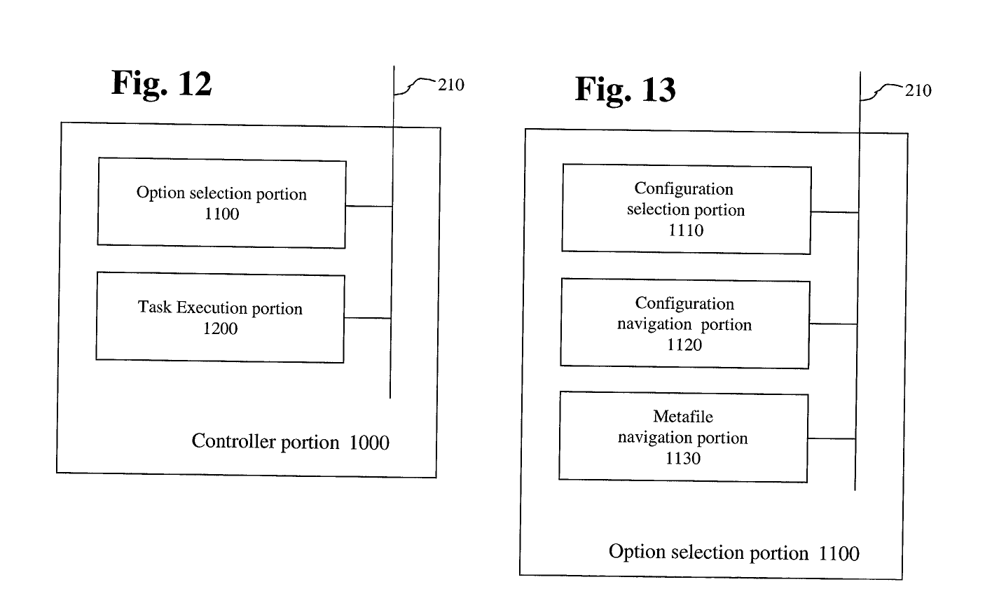

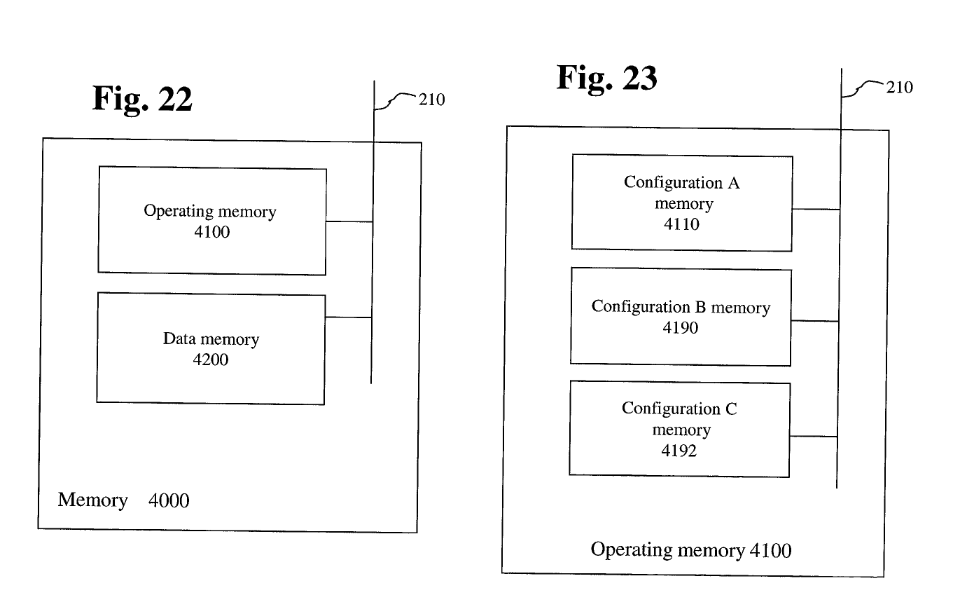

FIG. 12 - FIG. 21 show further aspects of the operating system 200 in accordance with an embodiment of the method and system of the invention and are described below. Also, further details of the memory 4000 are described hereinafter with reference to FIG. 22 - FIG. 27.

FIG. 22 shows the memory 4000 of FIG. 11 in further detail. As seen in FIG. 22, the memory 4000 contains an operating memory 4100 and data memory 4200.

FIG. 23 shows the operating memory of FIG. 22 in further detail. The operating memory 4100 stores the configuration files, such as in the configuration A memory 4110, configuration B memory 4190, and configuration C memory 4192, for example. The operating memory 4100 can store as many configurations as desired or necessary.

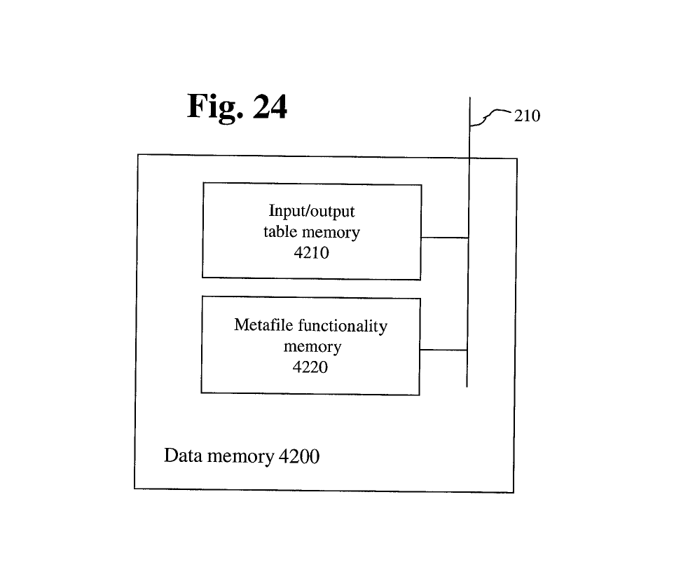

FIG. 24 provides a detailed illustration of the data memory 4200 in accordance with one embodiment of the invention. The data memory 4200 includes an input/output table memory 4210 and a metafile functionality memory 4220. The input/output table memory 4210 is constantly being monitored and changed by data flowing from the controller portion 1000 and the input/output control portion 2000. The metafile functionality memory 4220 is responsible for storing all of the information scanned from the metafiles that are displayed by the user interface portion 3000.

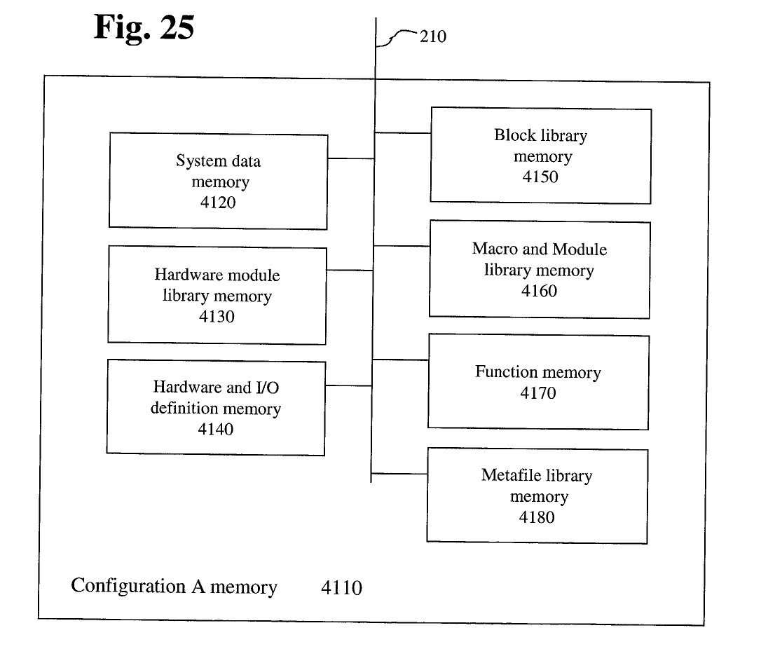

FIG. 25 shows in further detail the configuration A memory 4110 of FIG. 23, in accordance with one embodiment of the invention. Illustratively, the configuration A memory 4110 contains configuration items, i.e., the system data memory 4120, the hardware module library memory 4130, the hardware and I/O definition memory 4140, the block library memory 4150, the macro and module library memory 4160, the function memory 4170 and the metafile library memory 4180, for example.

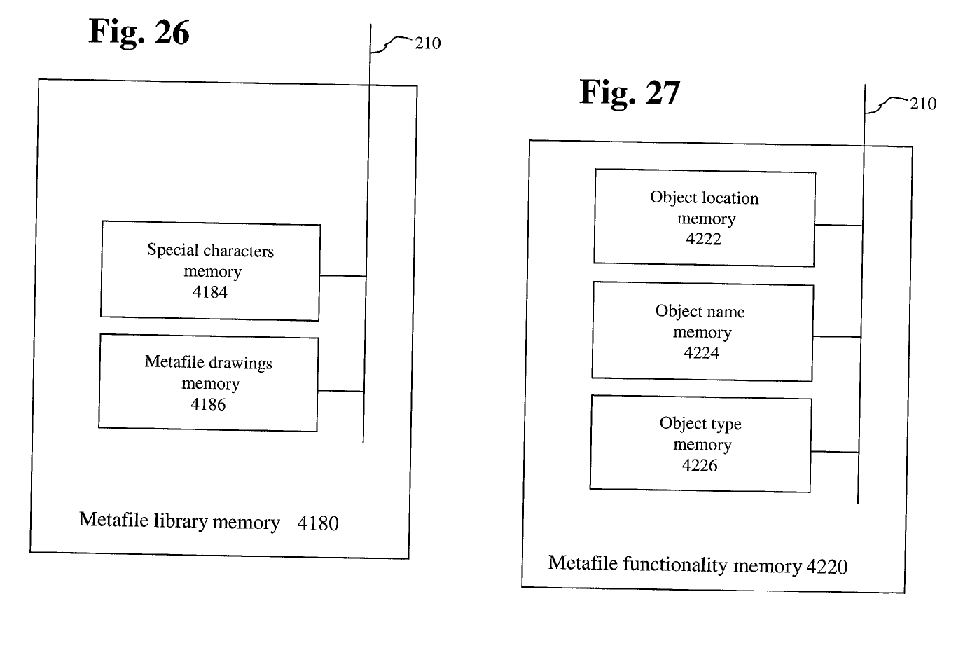

FIG. 26 shows in further detail the metafile library memory 4180 of FIG. 25, which includes a special character memory 4184 and a metafile drawing memory 4186. The special character memory 4184 is created by the block designer and includes the characters that the controller configuration application understands represent a certain functional aspect of block functionality. The metafile drawing memory 4186 contains the metafiles, i.e., the drawing data files, that have been associated with a block.

FIG. 27 shows in further detail the metafile functionality memory 4220 of FIG. 24, which includes an object location memory 4222, an object name memory 4224, and an object type memory 4226. These three sub-memories contained in the metafile functionality memory 4220 are responsible for placing the objects and inputs to the text functions so the invention can display the detailed block drawing in the controller configuration application.

Accordingly, FIG. 22 - FIG. 27 show various aspects of the illustrative memory 4000. The system and method in accordance with one embodiment of the invention will now be described in further detail with reference to FIG. 11 - FIG. 21.

As shown in FIG. 11 and as described in detail below, the controller portion 1000 directs and manages a controller configuration application, in the controller device 300, that the user utilizes through the user interface portion 3000. The controller portion 1000 tracks the input and output signals that pass through the input portion 220 and the output portion 240, respectively, that the input/output control portion 2000 places into the memory 4000. The controller portion 1000 reads the input/output values from memory 4000 and applies the values in the functional aspects of the configurations found in memory 4000. Additionally, the controller portion 1000 places the configuration output values in memory 4000 and also reports those values to the user interface portion 3000 for display to the user. The controller portion operates on a tasked schedule such that the user may observe the update of data signals as they are displayed on the user interface portion 3000. Furthermore, the controller portion 1000 monitors any user manipulation of functional values in the user interface portion 3000 and incorporates those into the configuration. Thus, presenting the user with the ability to modify the controller device configuration as is necessary or desired in the block drawing.

FIG. 12 shows the controller portion 1000 of FIG. 11 in further detail. As seen in FIG. 12, the controller portion 1000 contains an option selection portion 1100 and a task execution portion 1200. FIG. 13 shows the option selection portion 1100 of FIG. 12 in further detail. As seen in FIG. 13, the option selection portion 1100 contains the configuration selection portion 1110, the configuration navigation portion 1120, and the metafile navigation portion 1130. The configuration selection portion 1110 accesses the operating memory 4100 and displays a list of the configuration files contained therein for the user to select from. Within the controller configuration application, the configuration files are stored in the operating memory 4100. As shown in FIG. 23, the configuration files include the configuration A files, the configuration B files and the configuration C files, which are stored in the configuration A memory 4110, the configuration B memory 4190, and the configuration C memory 4192, for example. However, the operating memory 4100 can store as many configurations as is necessary or desired.

Once the configuration selection portion 1110 determines the complete list of configuration files contained in the operating memory 4100, the names of those configuration files are reported to the user interface portion 3000 for display to the user.

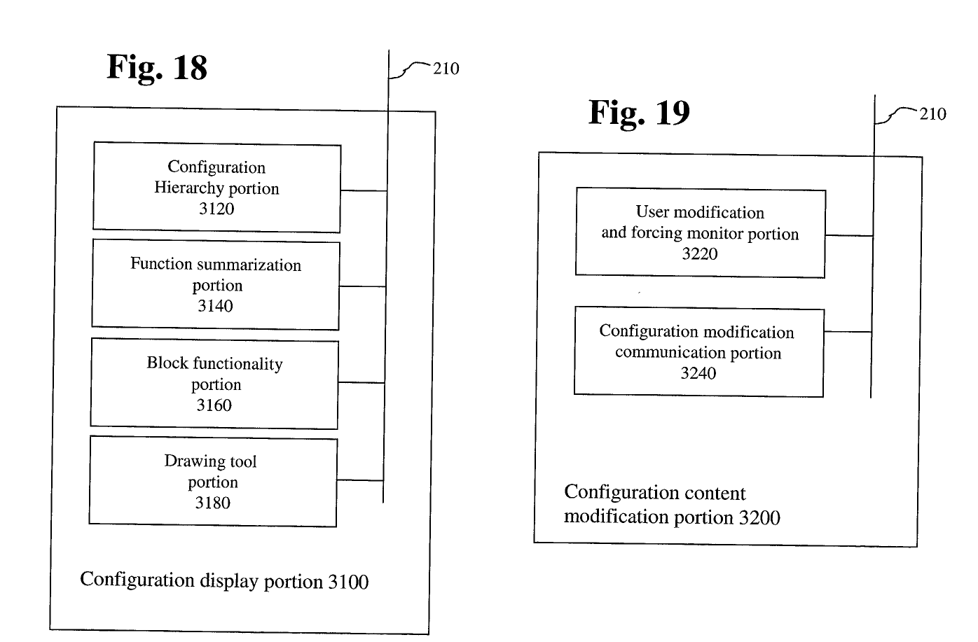

Once the user selects a configuration file suitable to configure the controller device 300 for the operating field device 400, the configuration navigation portion 1120 is responsible for directing the user interface portion 3000 to display the hierarchical view, in “tree view” fashion, of the configuration file. Specifically, the configuration navigation portion 1120 reads the configuration file, configuration A memory 4110, for example, from the operating memory 4100. It then reads the configuration items contained in the configuration memory 4100, such as the system data memory 4120, the hardware module library memory 4130, the hardware and I/O definition memory 4140, the block library memory 4150, the macro and module library memory 4160, the function memory 4170, and the metafile library memory 4180, for example. The configuration navigation portion 1120 then commands the configuration hierarchy portion 3120, as shown in FIG. 18, to display the list of configuration items present in configuration A memory 4110, for example, on the user interface 3000.

Additionally, the configuration navigation portion 1120 allows the user to select from any of the configuration items in configuration A memory 4110 and see the summarized view of the item in the user interface portion 3000. In operation, the user highlights a given configuration item, for example, block library memory 4150. The configuration navigation portion 1120 commands the configuration hierarchy portion 3120 to display the sub-components of the block library memory 4150. If the user highlights a block in the block library 4150, the configuration navigation portion 1120 commands the function summarization portion 3140 to display the functional representation of the block in the user interface portion 3000.

When the user selects a function configuration item from function memory 4170, the function and its sub-components, such as tasks, modules, macros or blocks, are displayed on the user interface as well, by the function summarization portion 3140.

FIG. 15 shows the metafile navigation portion 1130 of FIG. 13 in further detail. The metafile navigation portion 1130 provides the user with the option of observing a detailed drawing of a block's internal functionality. The user can utilize the metafile navigation portion 1130 after a configuration file is selected from the operating memory 4100. The metafile navigation portion 1130, as shown in FIG. 15, includes a drawing library scanner portion 1132, a text function scanner portion 1134, and a character stripping portion 1138.

In accordance with one embodiment of the system and method of the invention, the metafile navigation portion 1130 reads the configuration file selected by the user, such as configuration A memory 4110. The drawings library scanner portion 1132 reads the metafile drawings memory 4186, as shown in FIG. 26, and determines whether a metafile, i.e., a drawing data file stored in the configuration A memory 4110 is associated with a block in a highlighted configuration item. The metafile navigation portion 1130 takes those matching files from the metafile drawings memory 4186 and prepares them for visual display.

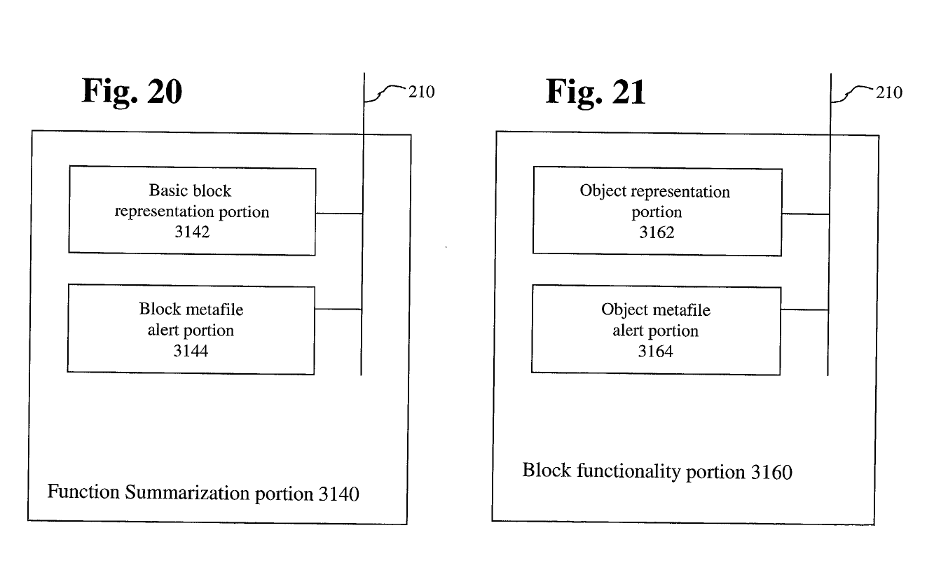

The drawings library scanner portion 1132 reports the results of its search to the function summarization portion 3140 and block metafile alert portion 3144, as shown in FIG. 20. When the drawings library scanner portion 1132 finds a metafile that is associated with a block in the highlighted configuration item, the block metafile alert portion 3144 displays a representative symbol, i.e. a metafile alert symbol, on the block as displayed in the summary view. The user then knows that a detailed drawing of the block's internal functionality exists in the configuration A memory 4110 and can be viewed. In other words, the user can “drill” into the stored detailed drawing by selecting the metafile alert symbol.

Illustratively, when the user selects a metafile alert symbol on a block, or in some other manner selects a particular block, the user initiates the text function scanner portion 1134. The text function scanner portion 1134 analyzes the metafile associated with the block. For every text function the text function scanner portion 1134 finds in the metafile, it checks the text function for embedded special characters matching those listed in the special character memory 4184.

Illustratively, the special characters may include:

{PARAMETER_TYPE, _T(“P. ”)}, to represent a parameter;

{V_COIL, _T(“|(v. ”) }, to represent a coil;

{P_JUMPER, _T(“{ P. ”) }, to represent a jumper;

{SIGNAL_TYPE, _T(“S. ”}, to represent a signal from another block; or

{LIVE_SIGNAL_TYPE, _T(“L. ”}, to represent a line signal.

When the text function scanner portion 1134 finds a text function, with special characters embedded therein matching any contained in the special characters memory 4184, the text function scanner portion 1134 understands what functional block aspect the text function represents. For example, the special characters may indicate a jumper representing signal flow, a parameter setting, a relay contact or coil that regulates power flow when connected to the device being configured, or live data values such as live signal types, and signal edit types, for example. The text function scanner portion 1134 checks the placement information of the text function in the metafile, and records the location of the text function's X, Y coordinates in the object location memory 4222. The text scanner portion 1134 also reads the name portion of the text function and places the name in the object name memory 4224, as shown in FIG. 27.

The text function scanner portion 1134 records the type of object represented by the text function, as determined by the special characters embedded therein, in the object type memory 4226. Thus, the text function scanner portion 1134 obtains all the information regarding any text function found in the metafile from the object location memory 4222, object name memory 4224, and the object type memory 4226.

Also, the text function scanner portion 1134 retrieves data signal values from the input/output table memory 4210. Accordingly, a displayed graphics item is associated with a data signal value using a special character item, i.e., by the common association of a data value signal and a displayed graphics item with the same special character item. Then, the character stripping portion 1138 removes the special characters from the each text function and commands the object representation portion 3162 to display the detailed drawing, with objects representing each text function, on the user interface. The user can then visualize the animated block functionality on the detailed block drawing.

A further aspect of the invention allows the block designer to create several levels of metafiles to represent a function in a configuration file. Thus, when the text function scanner portion 1134 identifies text functions with special characters embedded in them, it also identifies any text functions that may be present in the first detailed drawing, in the same manner performed as described above. When found, the text function scanner portion 1134 alerts the object metafile alert portion 3164, which creates a representative symbol to be displayed on the appropriate text function on the user interface, i.e., to indicate to a user that further information is available.

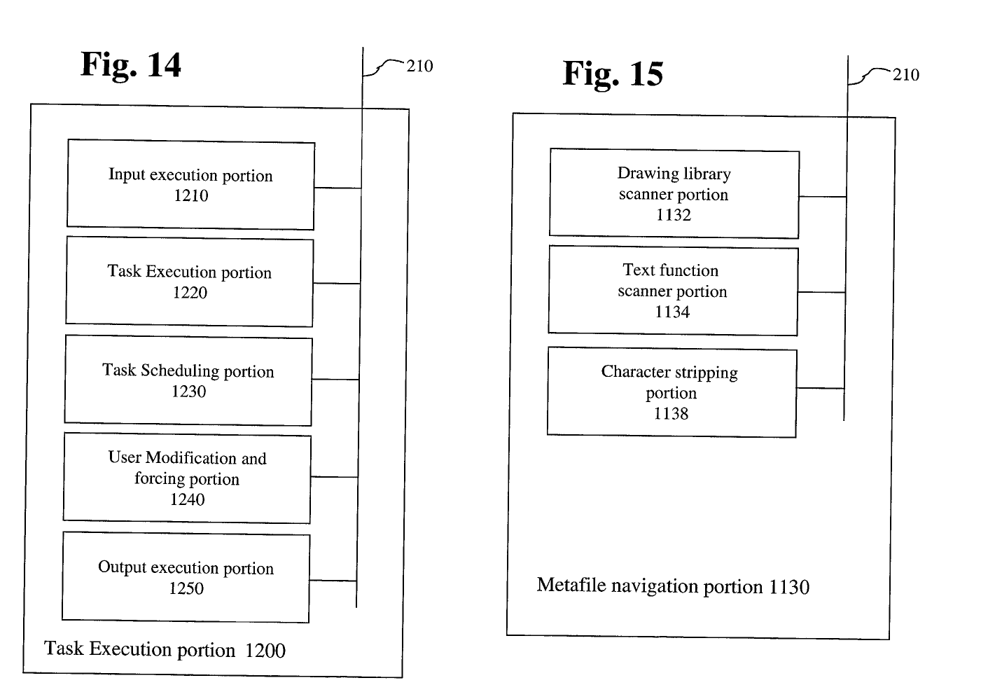

FIG. 14 depicts the task execution portion 1200 in further detail. The task execution portion 1200 directs the use of the configuration and data stored in memory 4000 and completes the configuration tasks, such as those in the function memory 4170 of configuration A memory 4110. The task execution portion 1200 includes an input execution portion 1210, a task execution portion 1220, a task scheduling portion 1230, a user modification and forcing portion 1240, and an output execution portion 1250.

Once the user chooses to open a configuration memory, the task execution portion 1200 begins its operation. While the configuration hierarchy portion 3120 displays the hierarchical view of the configuration memory, the function summarization portion 3140 displays the summarized view of any highlighted configuration item.

Simultaneously, the input execution portion 1210 scans the configuration A memory 4110 and its configuration items, including function memory 4170, to determine which input and output signals are necessary to execute the configuration tasks.

When finished, the input execution portion 1210 communicates with the input/output table memory 4210 to read those values and forward the values to the task execution portion 1220. The task execution portion 1220 inputs the values into the configuration task and determines an output. The task execution portion 1220 then reports the output value to the output execution portion 1250, which in turn, reports the information to the input/output table memory 4210.

The user modification and forcing portion 1240 as shown in FIG. 14 allows the user to change and override a live signal type or modify a function or other signal edit type in the configuration memory. In conjunction with the configuration content modification portion 3200, as shown in FIG. 19, the user modification and forcing portion 1240 allows the user to uniquely configure the controller device. In operation, the user selects a parameter, function or signal input of the configuration displayed on the user interface portion 3000. The user modification and forcing monitor portion 3220 presents the user with the modification options available for a given parameter, function or signal input, i.e., a live signal type, contact coil, or jumper, for example. The user selects the modification desired on the interface and the user modification and forcing monitor portion 3220 commands the configuration modification communication portion 3240 to report the desired modification to the user modification and forcing portion 1240, which in turn, effectuates the change in the execution of the configuration tasks.

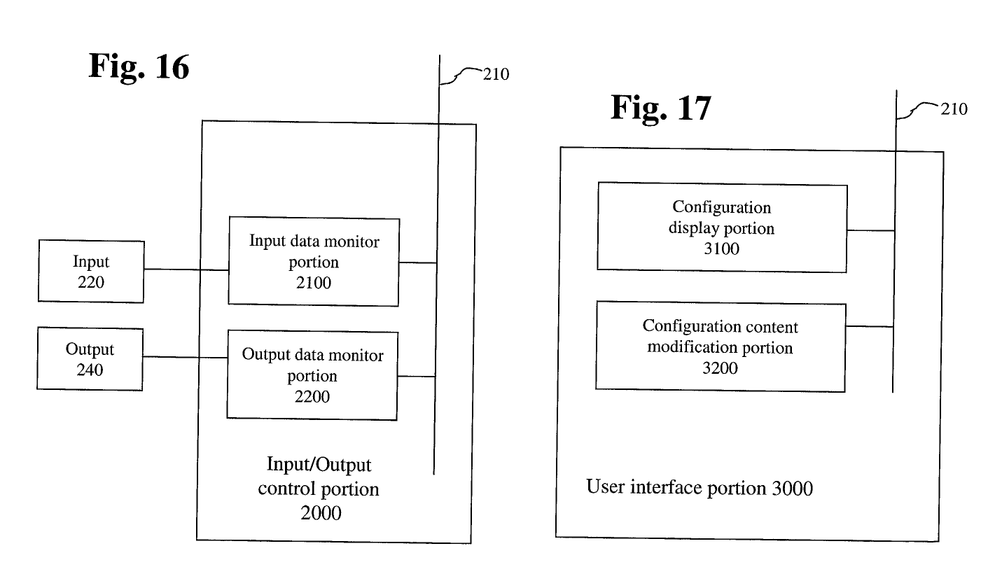

FIG. 16 illustrates in further detail the input/output control portion 2000 of FIG. 11 in accordance with one embodiment of the invention. The input/output control portion 2000 receives and sends information, in the form of data signals, to and from the controller device 300. The input/output control portion 2000 includes an input data monitor portion 2100 and an output data monitor portion 2200.

While the task execution portion 1200 is continuously communicating with the input/output table memory 4210, the input/output control portion 2000 is receiving input signals and sending output signals to the controller device being configured. In operation, input/output control portion 2000 acts as a middleman, transmitting information between the input/output table memory 4210 and the outside device being configured. Of course, the inputs from the input/output table memory 4210 are being monitored and/or configured by the user through the configuration content modification portion 3200 which effects changes in the controller portion 1000.

Thus, when the input data monitor portion 2100 receives a new input signal value, it records the information in the input/output table memory 4210 corresponding to the name given to that signal. The output data monitor portion 2200 simultaneously reads the input/output table memory 4210 to find the latest output signals returned by the output execution portion 1250, and sends those signals out to the controller device 300 as output through the output portion 240. The input data monitor portion 2100 continuously checks for new input values and continuously writes those to the input/output table memory 4210. Alternatively, the task scheduling portion 1230 controls the intervals in which the input execution portion 1210 goes to the input/output table memory 4210 to find new input signals for the task execution portion 1220. Therefore, the input execution portion 1210 does not necessarily go to the input/output table memory 4210 to retrieve a new signal value as soon as such new signal value is input to the table 4210. The new values are retrieved based on the task schedule determined in the task scheduling portion 1230.

FIG. 17 illustrates the user interface portion 3000 in accordance with one embodiment of the invention. The user interface portion 3000 includes a configuration display portion 3100 and a configuration content modification portion 3200. As seen in FIG. 18, the configuration display portion 3100 includes a configuration hierarchy portion 3120, a function summarization portion 3140, a block functionality portion 3160, and a drawing tool portion 3180. The configuration hierarchy portion 3120 displays the hierarchical view, or “tree” view, of the configuration after it has been loaded.

The function summarization portion 3140 displays information based on a selected configuration item. As shown in FIG. 20, the function summarization portion further includes a basic block representation portion 3142 and a block metafile alert portion 3144. The block representation portion 3142 summarizes the code contained in the block and presents it to the user interface portion 3000. The block metafile alert portion 3144 provides a representative symbol in the user interface so the user can understand that a more detailed drawing of the block exists and can be viewed.

The block functionality portion 3160 displays the metafile associated with a given block when the user selects the block metafile alert portion 3144. As seen in FIG. 21, the block functionality portion 3160 further includes an object representation portion 3162 and an object metafile alert portion 3164. The object representation portion 3162 displays the scanned metafile drawing in the user interface 3000. The object metafile alert 3164 provides a representative symbol in the user interface 3000 when a more detailed drawing exists for the object seen in the display.

The drawing tool portion 3180 receives the metafile information from the metafile functionality memory 4220 and generates the detailed drawing in the user interface. Furthermore, the drawing tool portion 3180 receives the signal inputs and outputs from the controller 1000 and displays the values in the user interface.

As described above, the system and method of the invention utilizes a user interface to interact with a human user. As used herein, a user interface includes any software, hardware or combination of hardware and software used in an operating system that allows a user to interact with the operating system. For example, a user interface may include any of a touch screen, keyboard, mouse, voice reader, voice recognizer, dialogue screen, menu box, a list, a checkbox, a toggle switch, a pushbutton or any other component that allows a user to receive information regarding the operation of the operating system and/or provide the operating system with information. Accordingly, the user interface is any device that provides communication between a user and the operating system. The information provided by the user to the operating system through the user interface may be in the form of a command, a selection or data, or other input, for example.

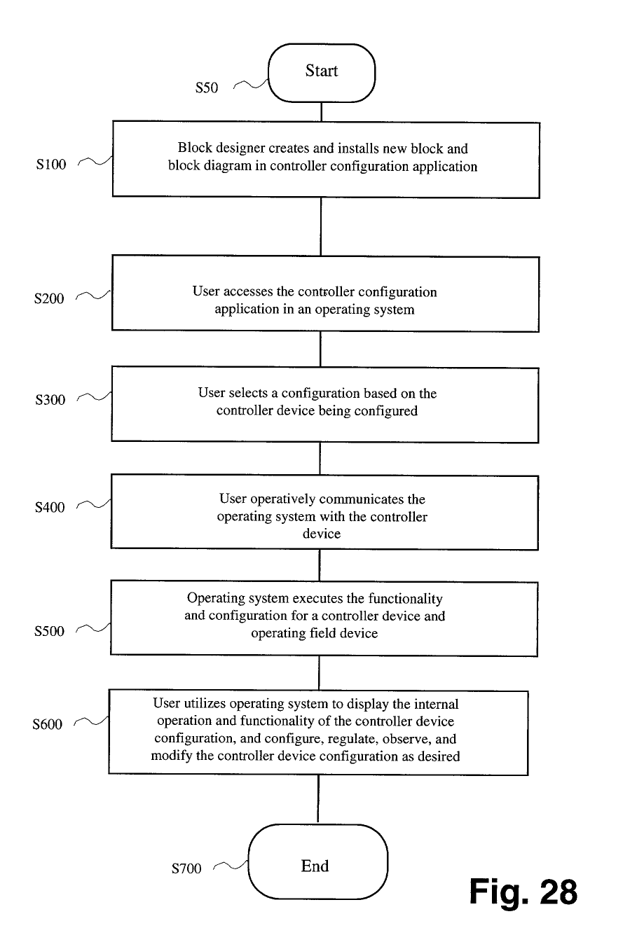

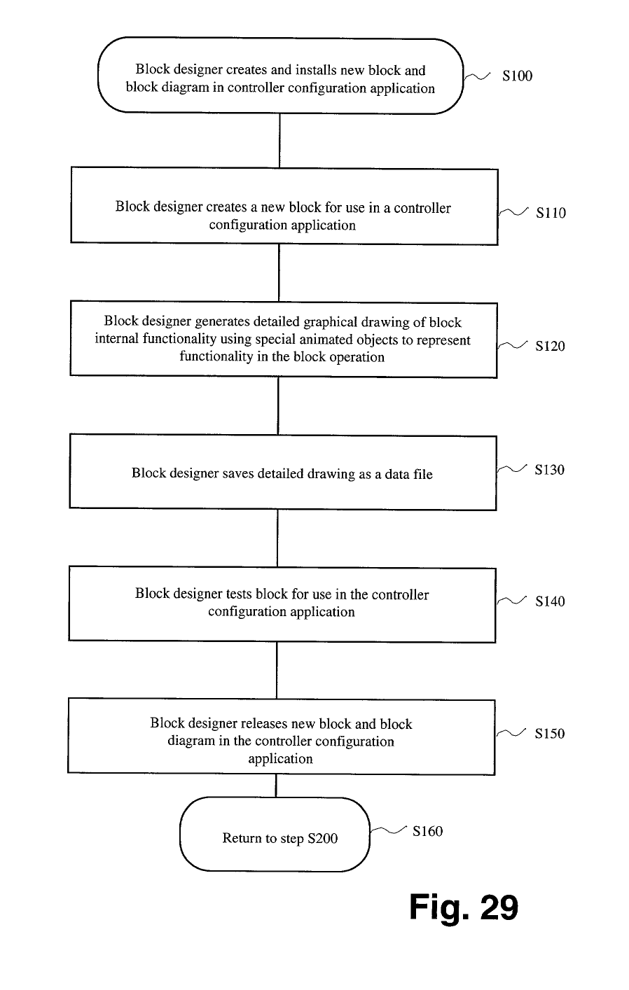

It should be appreciated that FIGS. 11-27 above illustrate an exemplary operating system. However, other operating systems that perform the method of the invention, as described further below with reference to FIGS. 28-40, may also be utilized. Further, it is to be appreciated that to practice the system and method of the invention, it is not necessary that an operating processor and/or the memory be physically located in the same place. That is, it should be appreciated that each of the processor and the memory may be located in geographically distinct locations and connected so as to communicate in any suitable manner, such as over a network, for example. Additionally, it should be appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations. Further, the memory could include or utilize memory stores from an Internet, Intranet, Extranet, LAN or some other source or over some other network, as may be necessary or desired.

As described above, the invention may illustratively be embodied in the form of a computer or computer operating system. It is to be appreciated that the software that enables the computer operating system to perform the operations described herein may be supplied on any of a wide variety of data holding media. Further, it should be appreciated that the implementation and operation of the invention may be in the form of computer code written in any suitable programming language, which provides instructions to the computer.

FIG. 28 is a flow chart in accordance with one embodiment of the present invention. As shown in FIG. 28, the invention begins with step S50. Then, the process passes to step S100. In step S100, the block designer creates and installs a new block and block diagram in a controller configuration application in an operating system. Then, in step S200, the user accesses the controller configuration application. After step S200, the process passes to step S300.

In step S300, the user selects a configuration file based on the controller device being configured. Then, in step S400, the user operatively communicates the operating system with the controller device. The process then passes to step S500. In step S500, the operating system executes the functionality and configuration for the controller device, which in turn controls the operating field device. Then, the process passes to step S600.

In step S600, the user utilizes the operating system to display the internal operation and functionality of the controller device configuration. Moreover, in step S600, the user can configure, regulate, observe, and modify the controller device configuration as desired. Then, in step S700, the process ends.

FIG. 29 is a flow chart that shows the step S1000, in which the block designer creates and installs a new block and block diagram in the controller * configuration application, in further detail. As shown in FIG. 29, the process begins instep S100. The process then passes to step S110. Instep S1l0, the block designer creates a new block for use in a controller configuration application. Then, in step S 120, the block designer generates a detailed graphical drawing of the block's internal functionality using special animated objects to represent functionality in the block. The process then passes to step S130.

In step S130, the block designer saves the detailed drawing as a data file. Then, in step S140, the block designer tests the block for use in the operating system. The process then passes to step S150. In step S150, the block designer installs the new block and block drawing in the controller configuration application. Then, in step S160, the process returns to step S200.

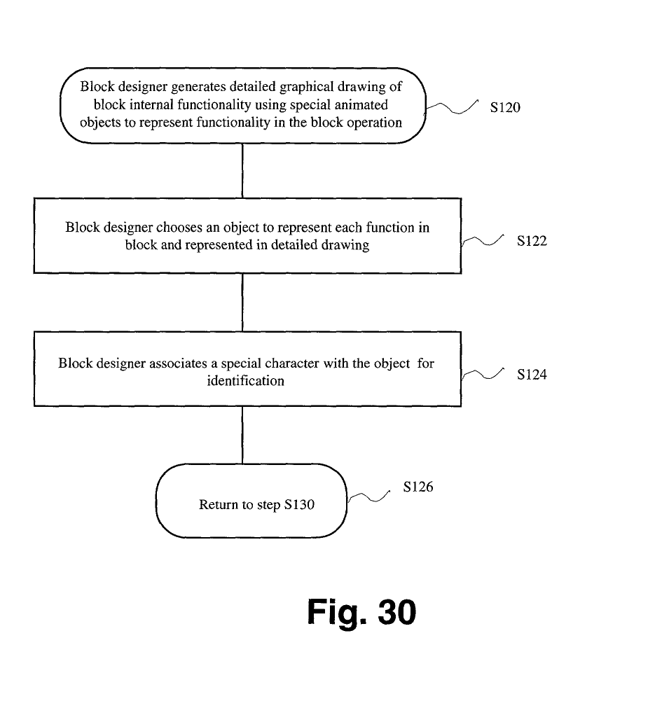

FIG. 30 is a flow chart that shows the step S120, in which the block designer generates a detailed graphical drawing of the block internal functionality using special animated objects to represent functionality in the block operation, in further detail. As shown in FIG. 30, the process begins in step S120. The process then passes to step S122 where the block designer chooses an object to represent each function in the detailed drawing. Then, in step S124, the block designer associates a special character with the object for identification. The process then passes to step S126. In step S126, the process returns to step S130.

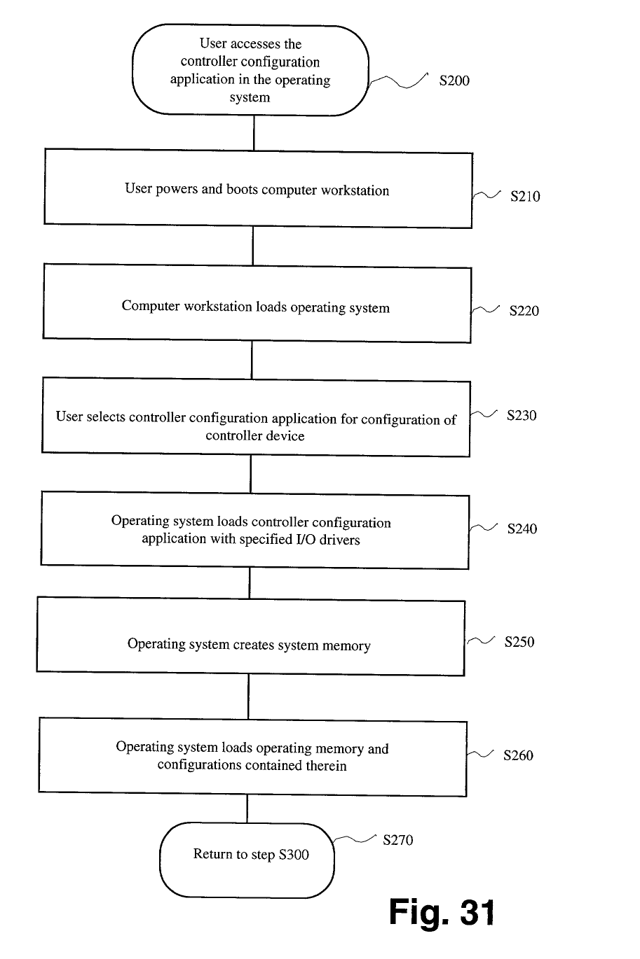

FIG. 31 is a flow chart that shows the step S200, in which the user accesses the operating system, in further detail. As shown in FIG. 31, the process begins in step S200. The process then passes to step S210. In step S210, the user powers and boots the computer workstation. Then, in step S220, the computer workstation loads the operating system. The process then passes to step S230.

In step S230, the user selects a controller configuration application for the controller device. Then, in step S240, the operating system loads the controller configuration application code with the specified I/O drivers. The process then passes to step S250. In step S250, the operating system creates a system memory. Then, in step S260, the operating system loads the operating memory and configurations contained therein. The process then passes to step S270. In step S270, the process returns to step S300.

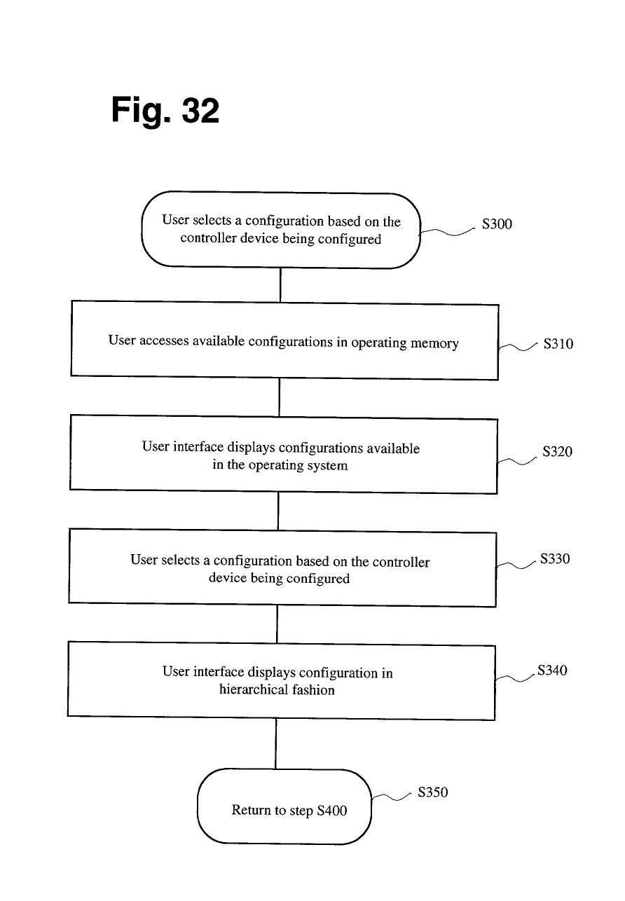

FIG. 32 is a flow chart that shows the step S300, in which the user selects a configuration based on the controller device being configured, in further detail. As shown in FIG. 32, the process begins in step S300. The process then passes to step S310. In step S310, the user accesses the available configurations in the operating memory. Then, in step S320, the user interface displays the configurations available in the operating system. The process then passes to step S330.

In step S330, the user selects a configuration based on the controller device being configured. Then, in step S340, the user interface displays the configuration selected in hierarchical fashion. The process then passes to step S350. In step S350, the process returns to step S400.

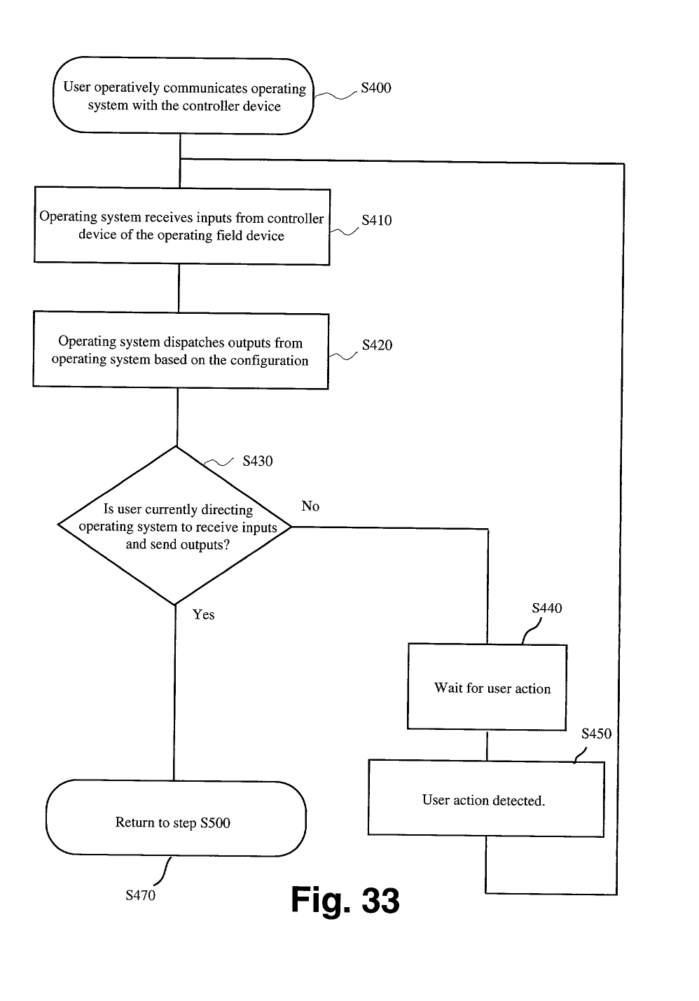

FIG. 33 is a flow chart that shows the step S400, in which the user operatively communicates the operating system with the controller device. As shown in FIG. 33, the process begins in step S400. The process then passes to step S410. In step S410, the operating system receives inputs from the controller device of the operating field device. Then, in step S420, the operating system dispatches outputs from the operating system based on the configuration. The process then passes to step S430.

In step S430, the process asks if the user is currently directing the operating system to receive inputs and send outputs. If no, the process passes to step S440. In step S440, the process waits for user action. Then, in step S450, when user action is detected, the process returns to step S410.

Alternatively, if in step S430, the user is directing the operating system to receive inputs and send outputs, the process passes to step S470. In step S470, the process returns to step S500.

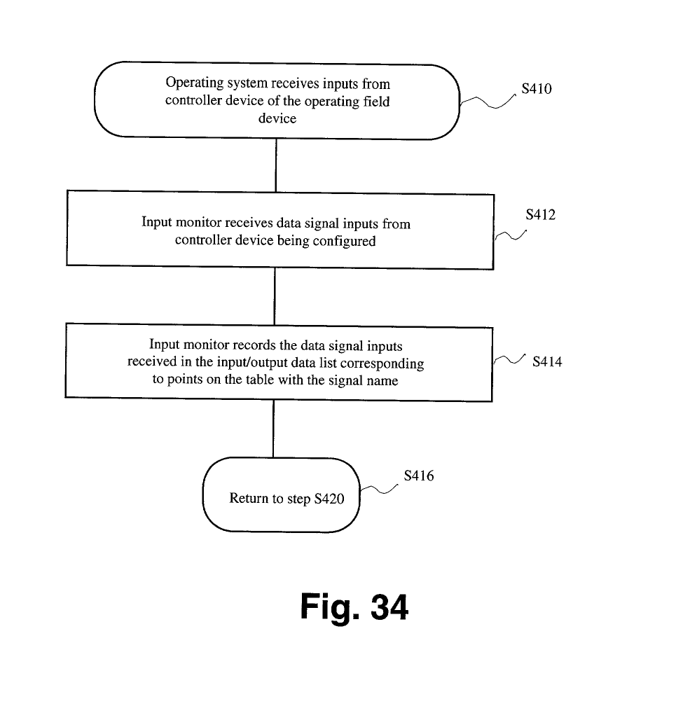

FIG. 34 is a flow chart that shows the step S410 of FIG. 33, in which the operating system receives inputs from the controller device of the operating field device, in further detail. As shown in FIG. 34, the process begins in step S410. The process then passes to step S412. In step S412, the input monitor receives data signal inputs from the controller device being configured.

Then, in step S414, the input monitor records the data signal inputs received in the input/output data list corresponding to points on the table with the signal name. The process then passes to step S416. In step S416, the process returns to step S420.

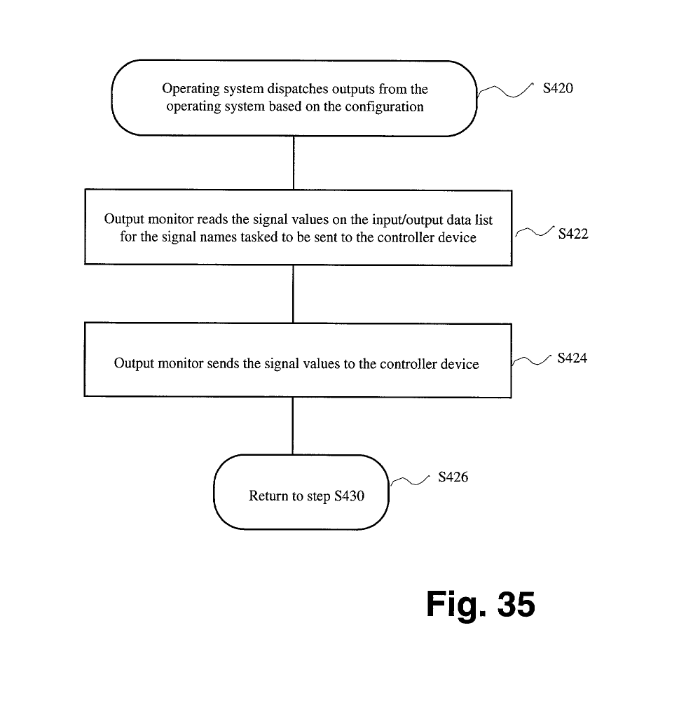

FIG. 35 is a flow chart that shows the step S420 of FIG. 33, in which the operating system dispatches outputs from the operating system based on the configuration, in further detail. As shown in FIG. 35, the process begins in step S420. The process then passes to step S422. In step S422, the output monitor reads the signal values on the input/output data list for the signal names tasked to be sent to the controller device. Then, in step S424, the output monitor sends the signal values to the controller device. The process then passes to step S426. In step S426, the process returns to step S430.

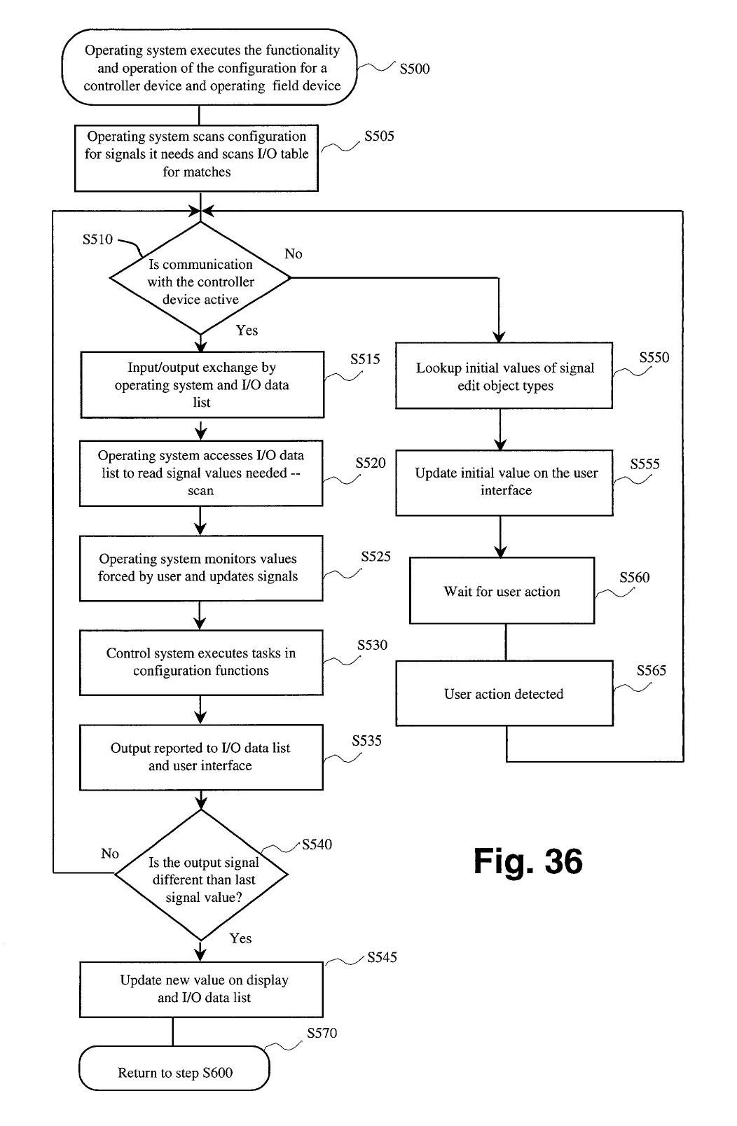

FIG. 36 is a flow chart that shows the step S500 of FIG. 28, in which the operating system executes the functionality and operation of the configuration for a controller device and operating device, in further detail in accordance with one embodiment of the system and method of the invention. As shown in FIG. 36, the process begins in step S500. The process then passes to step S505.

In step S505, the operating system scans the configuration for signals the operating system needs and scans the I/O table for matching signal points. Then, in step S510, the process determines whether communication with the controller device is active. If no, the process passes to step S550. In step S550, the operating system looks up the initial values of signal edit object types. Then, in step S555, the operating system updates the initial values on the user interface. The process then passes to step S560, where the operating system waits for user action. Then, in step S565, user action is detected and the process is returned to step S510.

Alternatively, if in step S510, the process determines that communication with the controller device is active, the process passes to step S515. In step S515, input/output is exchanged on the I/O data list. Then, in step S520, the operating system accesses the I/O data list to read the signal values the operating system needs. The process then passes to step S525.

In step S525, the operating system monitors values forced by the user and updates signals. Then, in step S530, the operating system executes the tasks in the configuration functions. The process then passes to step S535. In step S535, the output is reported to the I/O data list and user interface. Then, in step S540, the process determines if the latest output signal is different than the last corresponding signal value reported. If no, the process returns to step S5 10.

Alternatively, if in step S540, the process determines that the latest output signal is different than the last corresponding signal value reported, the process passes to step S545. In step S545, the operating system updates the new signal value on the display and I/O data list. Then, the process passes to step S570. In step S570, the process returns to step S600.

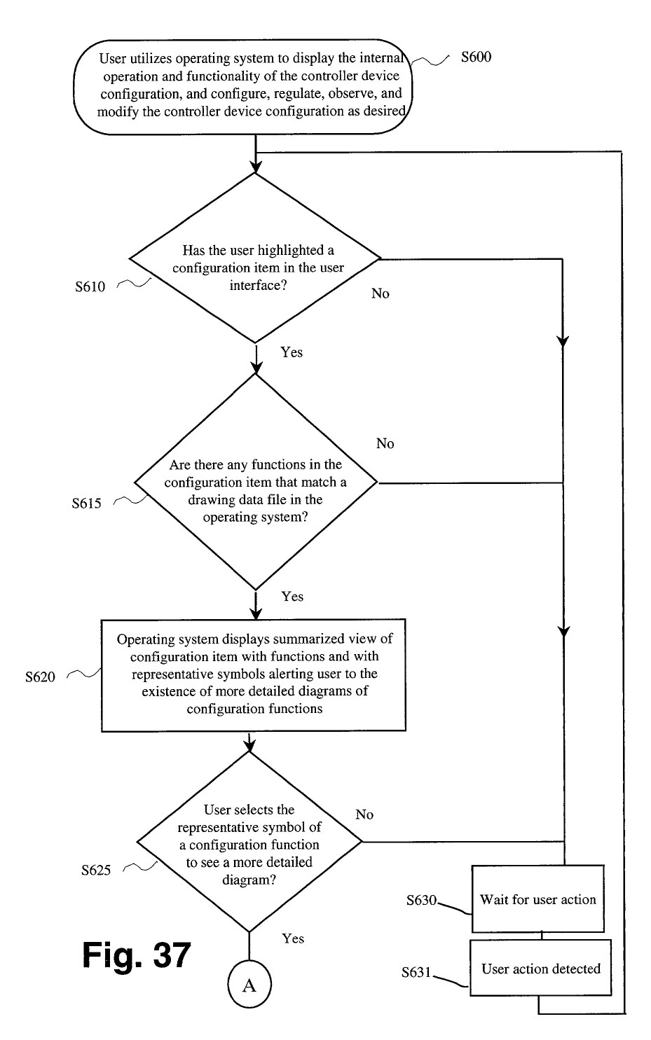

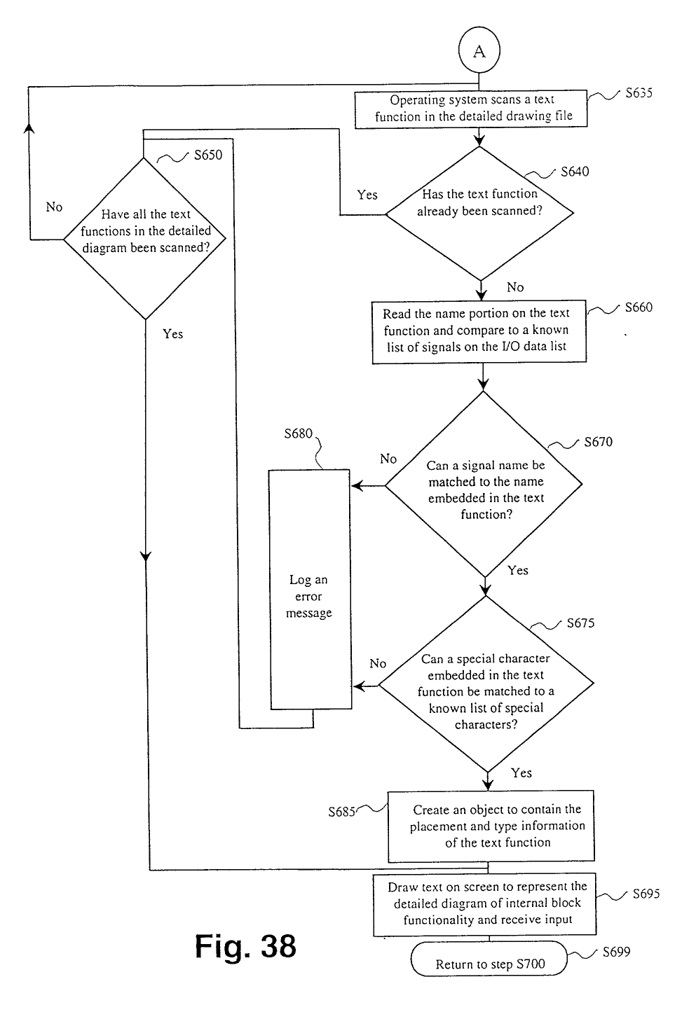

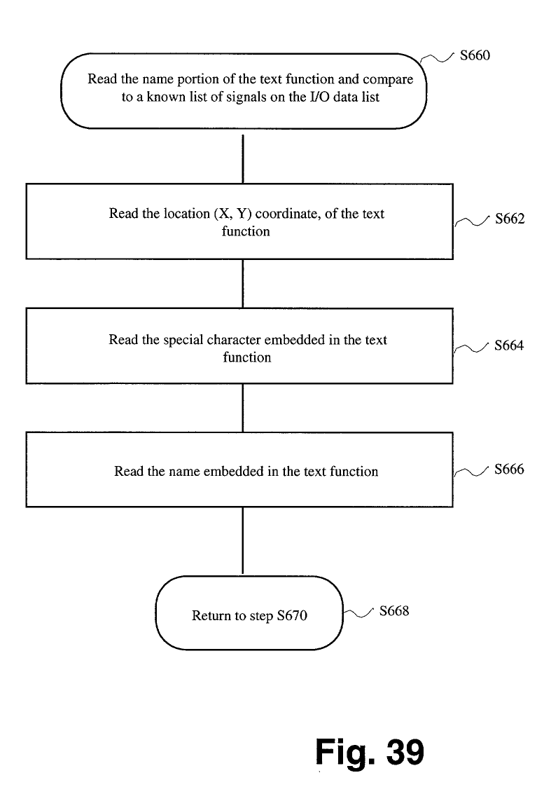

FIGS. 37 and 38 are flow charts that show the step S600 of FIG. 28, in which the user utilizes the operating system to display the internal operation and functionality of the controller device configuration, and can configure, regulate, observe, and modify the controller device configuration as desired, in further detail. As shown in FIG. 36, the process begins in step S600. The process then passes to step S610. In step S610, the process determines whether the user has highlighted a configuration item in the user interface. If no, the process passes to step S630. Then, in step S630, the operating system waits for user action. In step S631, the operating system detects user action and returns to step S610.

Alternatively, if in S610, the process determines that the user has highlighted a configuration item in the user interface, the process passes to step S615. In step S615, the process determines if there are any blocks in the configuration item that match a detailed drawing data file, i.e., a metafile in the memory of the operating system. If no, the process passes to step S630. Then, in step S630, the operating system waits for user action. In step S631, the operating system detects user action and returns to step S610, as shown in FIG. 37.

Alternatively, if in S615, the process detects blocks in the configuration item that match a data file in the operating system, the process passes to S620. In step S620, the operating system displays a summarized view of the configuration item with representative symbols alerting the user to the existence of a more detailed drawing of the configuration item. The process then passes to step S625.

In step S625, the process determines whether the user selects a representative symbol to see a more detailed drawing of a configuration item. If no, the process passes to step S630. Then, in step S630, the operating system waits for user action. In step S631, the operating system detects user action and returns to step S610.

Alternatively, if in step S625, the process determines that the user selects a representative symbol to see a more detailed drawing of a configuration item, the process passes to step S635, as shown in FIG. 38. In step S635, the operating system scans a text function in the detailed diagram, i.e., in the drawing data file. The process then passes to step S640. In step S640, the process determines whether a text function has already been scanned. If yes, the process passes to step S650.

In step S650, the process determines whether all the text functions in the detailed drawing data file have been scanned. If no, the process returns to step S635. Alternatively, if in step S650, the process determines that all the text functions in the detailed drawing have been scanned, the process passes to step S695.

Alternatively, if in step S640, the process determines that the scanned text function has not been scanned, the process passes to step S660. In step S660, the operating system reads the name portion of the text function and compares it to the list of signals on the I/O data list. The process then passes to step S670. In step S670, the process determines whether a signal name on the I/O data list can be matched to the name portion of the text function. If no, the process passes to step S680.

In step S680, the operating system logs an error message. The process then returns to S650. In step S650, the process determines whether all the text functions in the detailed drawing have been scanned. If no, the process returns to step S635. Alternatively, if in step S650, the process determines that all the text functions in the detailed diagram have been scanned, the process passes to step S695.

Alternatively, if in step S670, the process matches a signal name on the I/O data list with the name portion of a text function, the process passes to step S675. In step S675, the process determines whether a special character embedded in the text function can be matched to the known list of special characters. If no, the process passes to step S680. In step S680, the operating system logs an error message. The process then returns to S650. In step S650, the process determines whether all the text functions in the detailed drawing have been scanned. If no, the process returns to step S635. Alternatively, if in step S650, the process determines that all the text functions in the detailed diagram have been scanned, the process passes to step S695.

Alternatively, if in step S675, the process detects a special character embedded in the text function that can be matched to the known list of special characters, the process passes to step S685. In step S685, the operating system creates an object, based on the matched special character on the list, to contain the placement and type information in the text function. Then, the process passes to step S695.

In step S695, the operating system draws the object on the user interface to provide a detailed drawing of the internal block functionality and receive input. Then, the process passes to step S699. In step S699, the process returns to step S700.

FIG. 39 is a flow chart that shows step S660 of FIG. 38, in which the operating system reads the name portion of the text function and compares it to a known list of signals on the 1/0 data list. As shown in FIG. 39, the process begins with step S660. The process then passes to step S662. In step S662, the operating system reads the location (X, Y) of the text function. Then, in step S664, the operating system reads the special characters embedded in the text function. The process then passes to step S666. In step S666, the operating system reads the name portion of the text function. Then, in step S668, the process returns to step S670.

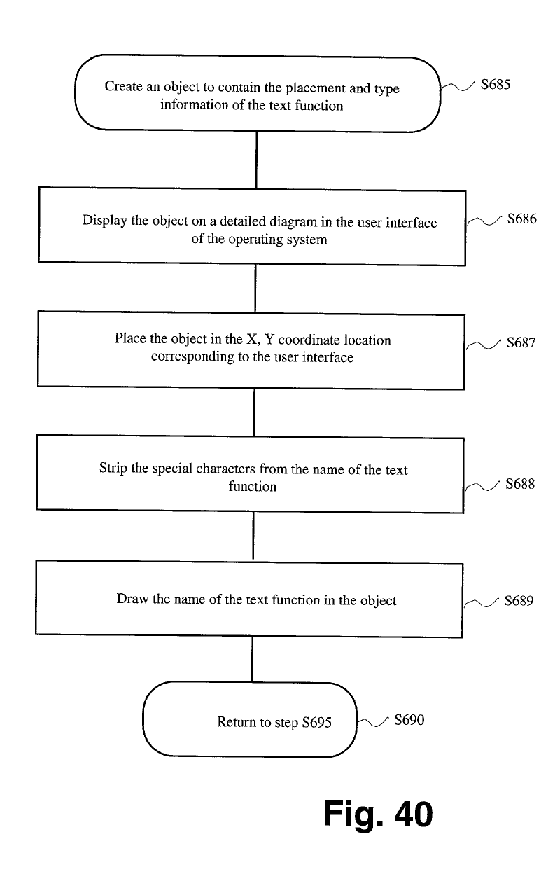

FIG. 40 is a flow chart that shows step S685 of FIG. 38, in which the operating system creates an object to contain the placement and type information in the text function. As shown in FIG. 40, the process begins in step S685. The process then passes to step S686. In step S686, the operating system creates an object on a diagram for display in the user interface. Then, in step S687, the operating system places the object in the X, Y location on the diagram. Then, in step S688, the operating system strips the special characters from the name portion of the text function. The process then passes to step S689. In step S689, the operating system types the name portion on the object on the diagram. Then, in step S690, the process returns to step S695.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method of displaying the internal functions of a block, comprising:
identifying a selected block having a block identifier;
searching a data file having a plurality of drawing files, using the block identifier, to identify a matching drawing file that is associated with the block identifier;
scanning the matching drawing file to identify special character items in the matching drawing file;
associating each special character item that is identified in the scanning with a graphics item;
stripping each special character item that is identified in the scanning from the matching drawing file to generate a modified matching drawing file; and
generating a display based on the modified matching drawing file and each identified graphics item representing the internal functions of the block.

2. The method of claim 1, wherein the step of identifying a selected block having a block identifier includes:
displaying a plurality of displayed blocks of a control configuration on a user interface;
generating an alert indicator for each of the displayed blocks that a user can view in further detail; and
accepting a user selection for one of the displayed blocks, for which an alert signal is generated, to identify the selected block.

3. The method of claim 1, wherein the step of identifying a selected block having a block identifier includes accepting user input to identify the selected block.

4. The method of claim 1, wherein the internal functions of the block include at least one of the group consisting of parameters, parameter settings, drawing names, device names, open contacts, closed contacts, jumpers, enumerated jumpers, parameter jumpers, signal jumpers, coils, relays, live signals and edit signals.

5. The method of claim 1, wherein the matching drawing file includes text function items, the text function items including a name portion and a special character item.

6. The method of claim 5, wherein generating the display includes displaying the name portion of at least one text function item with a corresponding identified graphics item.

7. The method of claim 5, wherein at a least one text function item includes positional coordinates, and wherein the generating the display includes positioning an identified graphics item on a display based on the positional coordinates.

8. The method of claim 1, wherein generating the display includes displaying at least one live signal in the selected block, the live signal being output or input from a controller device.

9. The method of claim 8, further including forcing the live signal to a desired value.

10. A method of displaying the internal functions of a block, comprising:
identifying a selected block having a block identifier;
searching a data file having a plurality of drawing files, using the block identifier, to identify a matching drawing file that is associated with the block identifier; scanning the matching drawing file to identify text function items, having a name portion and a special character item, in the matching drawing file;
associating each special character item that is identified in the scanning with a graphics item;
associating each special character item that is identified in the scanning with a data signal;
associating each graphics item associated with a special character item with the data signal associated with the same special character item;
stripping the special character item from each text function item, that is identified in the scanning, from the matching drawing file to generate a modified matching drawing file; and
generating a display based on the modified matching drawing file and each text function item that includes the name portion and the respective data signal associated with each identified graphics item to represent the internal functions of the block.

11. The method of claim 10, wherein the data signals associated with each special character item represent inputs or outputs to a controller device.

12. The method of claim 10, wherein the step of associating each special character item that is identified in the scanning with a graphics item includes:
accessing a compilation of known special characters, wherein each known special character is associated with a predetermined graphics item representing an internal function of a block;
matching each special character item identified in the scanning with a known special character on the compilation of known special characters;
associating each special character item identified in the scanning with a predetermined graphics item, based on the step of matching each special character item identified in the scanning with a known special character on the compilation of known special characters.

13. The method of claim 10, wherein the step of associating each special character item that is identified in the scanning with a data signal includes:
supplying the block with data signals, each having a signal identifier and a signal value;
matching the name portion of each text function item identified in the scanning with the signal identifier of a data signal; and
associating the signal value of each data signal matched to the name portion of a special character item with the special character item.

14. The method of claim 13, wherein the step of supplying the block with data signals includes operatively communicating the block with a device that controls an operating field device.

15. The method of claim 14, further including the step of monitoring the device that controls the operating field device using the generated display representing the internal functions of the block.

16. The method of claim 14, further including the step of accepting user input to modify the internal functions of the block, on the generated display, to configure the device that controls the operating field device.

17. The method of claim 14, further including the step of accepting user input to modify the data signals supplied to the block, on the generated display, to configure the device that controls the operating device.

18. A control system for controlling an operating field device, comprising:
a control device in communication with the operating field device, the control device sending and receiving data signals to the operating field device wherein the data signals control the operation of the operating field device;
an operating system in communication with the control device, the operating system receiving and sending data signals to the control device to configure the control device, the operating system including:
a user interface portion that interfaces with a user using a user interface;
a controller portion, the controller portion accepting user input from the user interface portion to identify a selected block displayed on the user interface; and
a memory portion, the controller portion matching the selected block with a matching drawing file in the memory portion;
wherein the controller portion:
scans the matching drawing file for text function items, having a name portion and a special character item;
associates each special character item with a predetermined graphics item and a data signal from the control device;
strips the special character item from each text function item; and
generates a display based on the modified matching drawing file on the user interface, wherein the controller portion displays the predetermined graphics item, name portion, and data signal associated with each text function item to represent the internal functions of the block.

19. The control system of claim 18, wherein the controller portion utilizes a controller configuration application.

20. The control system of claim 18, wherein the controller portion displays a selected configuration and configuration items associated with the selected configuration, the selected block being included in one of the configuration items.

21. The control system of claim 20, wherein the controller portion displays a plurality of displayed blocks, the controller portion determining whether each of the displayed blocks have a corresponding drawing file in the memory portion and if so, displaying an alert symbol for each displayed block that has a corresponding drawing file.

22. The control system of claim 18, wherein the controller portion displays a plurality of displayed blocks, the controller portion determining whether each of the displayed blocks have a corresponding drawing file in the memory portion and if so, displaying an alert symbol for each displayed block that has a corresponding drawing file.

23. The control system of claim 18, wherein the text function item includes positional coordinates associated with the special character item.

24. The control system of claim 18, wherein the controller portion associates the positional coordinates with the predetermined graphics item when the controller portion strips the special character from the text function.

25. An operating system for displaying the details of a block, comprising:
a user interface portion that interfaces with a user using a user interface;
a controller portion, the controller portion accepting user input from the user interface portion to identify a selected block displayed on the user interface; and
a memory portion, the controller portion matching the selected block with a matching drawing file in the memory portion;
wherein the controller portion:
scans the matching drawing file for text function items, having a name portion and a special character item;
associates each special character item with a predetermined graphics item;
strips the special character item from each text function item to generate a modified matching drawing file; and
generates a display based on the modified matching drawing file on the user interface, wherein the controller portion displays the predetermined graphics item and name portion to represent the internal functions of the block.

26. The operating system of claim 25, wherein the controller portion associates the predetermined graphics item with a data signal.

27. The operating system of claim 26, wherein the data signal is received from a controller device.

28. The operating system of claim 25, wherein the controller portion outputs configuration information to a controller device.

29. The operating system of claim 25, wherein the controller portion displays a selected configuration and configuration items associated with the selected configuration.

30. An operating system for displaying the details of a block, comprising:
means for identifying a selected block having a block identifier;
means for searching a data file having a plurality of drawing files, using the block identifier, to identify a matching drawing file that is associated with the block identifier;
means for scanning the matching drawing file to identify special character items in the matching drawing file;
means for associating each special character item that is identified in the scanning with a graphics item;
means for stripping each special character item that is identified in the scanning from the matching drawing file to generate a modified matching drawing file; and
means for generating a display based on the modified matching drawing file and each identified graphics item representing the internal functions of the block.

31. A control system for controlling an operating field device, comprising:
means for identifying a selected block having a block identifier;
means for searching a data file having a plurality of drawing files, using the block identifier, to identify a matching drawing file that is associated with the block identifier;
means for scanning the matching drawing file to identify text function items, having a name portion and a special character item, in the matching drawing file;
means for associating each special character item that is identified in the scanning with a graphics item;
means for associating each special character item that is identified in the scanning with a data signal;
means for associating each graphics item associated with a special character item with the data signal associated with the same special character item;
means for stripping the special character from each text function item, that is identified in the scanning, from the matching drawing file to generate a modified matching drawing file; and
means for generating a display based on the modified matching drawing file and each text function item that includes the name portion and the respective data signal associated with each identified graphics item to represent the internal functions of the block.
